(19) United States
(12) Patent Application Publication
(10) Pub. No.: US 2025/0332541 A1
(43) Pub. Date: Oct. 30, 2025

(54) TRIPLY PERIODIC MINIMAL SURFACE SORBENT CONTACTORS FOR CARBON CAPTURE

(71) Applicants: ExxonMobil Technology and Engineering Company, Annandale, NJ (US); GEORGIA TECH RESEARCH CORPORATION, Atlanta, GA (US)

(72) Inventors: Simon C. Weston, Annandale, NJ (US); Ryan P. Lively, Atlanta, GA (US); Seoyul Kim, Atlanta, GA (US); Hannah E. Holmes, Atlanta, GA (US)

(21) Appl. No.: 19/180,658

(22) Filed: Apr. 16, 2025

Related U.S. Application Data
(60) Provisional application No. 63/640,311, filed on Apr. 30, 2024.

(51) Int. Cl. B01D 53/62; B01D 53/04; B01J 20/26

(52) U.S. Cl. CPC B01D 53/62; B01D 53/0462; B01J 20/262; B01D 2253/108; B01D 2257/504

(57) ABSTRACT

Disclosed embodiments may include a method of making a sorbent-based contactor. The method may include generating a template having a void. The method may include injecting a polymer-based ink into the void, wherein the polymer-based ink includes a sorbent. The method may include contacting the template with a solvent thereby generating the sorbent-based contactor by simultaneously, over a first time, (i) dissolving the template, and (ii) phase inverting the polymer-based ink. The sorbent-based contactor may include up to approximately 75 weight percent of the sorbent relative to the sorbent-based contactor.

### CROSS-REFERENCE TO RELATED APPLICATIONS

The present application claims priority to U.S. Provisional Patent Application No. 63/640,311, filed Apr. 30, 2024, the entire contents of which are fully incorporated herein by reference.

### FIELD

The present application relates to sorbent-based contactors, and methods of using and making the same. Said contactors may have a Triply Periodic Minimal Surface (TPMS) structure, and be used in carbon separation processes.

### BACKGROUND

Direct capture of carbon dioxide (CO₂) from ambient air (Direct Air Capture, DAC) is a vital piece of the portfolio of negative emissions technologies that will be required to combat climate change. However, separating CO₂ from the atmosphere provides several challenges. It requires highly selective adsorbents for capturing dilute CO₂ (e.g., about 400 ppm) over other higher-concentration air components, such as nitrogen (N₂), oxygen (O₂), and water. Over the past decade, developing sorbents that meet this requirement has been the focus for the DAC field, and as a result, a few promising candidate materials have been developed, such as amine-impregnated sorbents, which exhibit high CO₂ selectivity and working capacity from simulated air under humid conditions in a temperature swing adsorption (TSA) process.

Additionally, utilizing the sorbents in powder form is not industrially practical due to difficult handling, high pressure drop, and poor mechanical stability. The conventional method for formulating powders in shaped bodies is mechanical densification (e.g., pressed pellets). However, due to high pressure drops in pellet-packed beds, mechanical densification is not considered optimal for DAC, which requires as low of air pressure drops as possible. Feed air for DAC is almost infinite, which positions productivity as one of DAC units' most important cost drivers.

Other methods, such as integration of sorbents into pores of polymerized high internal phase emulsions (poly-HIPEs) and polymerization from Pickering emulsions, have also been utilized to prepare sorbent/polymer composites. However, their macroscopic shapes have been mostly limited to simple geometries.

In view of the above, it would be desirable to develop a method for structuring powder sorbents into macroscopic architectures such that they have higher mass and heat transport efficiencies than traditional sorbents.

### SUMMARY

The various embodiments of the disclosure relate generally to methods and systems for carbon capture using TPMS sorbent contactors.

A first embodiment may include a contactor configured for use in a separation process. The contactor may have a TPMS shape, a first channel, and a second channel not intersecting with the first channel. The contactor may also have a sorbent in an amount of up to approximately 75 weight percent of the contactor.

A second embodiment may include a method of making a sorbent-based contactor. The method may include generating a template having a void. The method may include injecting a polymer-based ink into the void, wherein the polymer-based ink includes a sorbent. The method may include contacting the template with a solvent thereby generating the sorbent-based contactor by simultaneously, over a first time, (i) dissolving the template, and (ii) phase inverting the polymer-based ink. The sorbent-based contactor may include up to approximately 75 weight percent of the sorbent relative to the sorbent-based contactor.

A third embodiment may include another method of making a sorbent-based contactor. The method may include selecting a template having a void. The method may include mixing a polymer ink with a sorbent to generate a polymer ink/sorbent mixture. The method may include injecting the polymer ink/sorbent mixture into the void. The method may include generating the contactor by contacting the template with a solvent for a first time period thereby simultaneously removing the template and phase inverting the polymer ink/sorbent mixture. The contactor may include up to approximately 75 weight percent of the sorbent relative to the contactor.

These and other features and attributes of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1A illustrates a Templated Phase Inversion (TPI) method for preparing TPMS contactors, in accordance with certain embodiments of the disclosed technology.

FIG. 1B provides photographic and scanning electron microscope (SEM) images of a small cellulose acetate (CA) contactor in gyroid shape, in accordance with certain embodiments of the disclosed technology.

FIG. 1C provides photographic and SEM images of a large CA contactor in gyroid shape, in accordance with certain embodiments of the disclosed technology.

FIG. 1D provides a cross-sectional image from micro-CT of the contactor of FIG. 1B, in accordance with certain embodiments of the disclosed technology.

FIG. 1E provides a three-dimensional (3D) image of the contactor of FIG. 1B reconstructed from micro-CT, in accordance with certain embodiments of the disclosed technology.

FIGS. 1F-1G provide a comparison between the contactor of FIG. 1B and the 3D printed poly(vinyl alcohol) (PVA) template for preparing the contactor, in accordance with certain embodiments of the disclosed technology.

FIG. 2A provides a sorbent contactor in a gyroid shape, in accordance with certain embodiments of the disclosed technology.

FIG. 2B provides a sorbent contactor in a Schwarz diamond shape, in accordance with certain embodiments of the disclosed technology.

FIG. 2C provides a sorbent contactor in a Schwarz primitive shape, in accordance with certain embodiments of the disclosed technology.

FIGS. 3A-3F provide photographic and SEM images of gyroid sorbent contactors with various sorbents, in accordance with certain embodiments of the disclosed technology.

FIG. 3G provides sorbent loading in the composites of FIGS. 3A-3F calculated from the decomposition under air, in accordance with certain embodiments of the disclosed technology.

FIG. 3H provides Brunauer-Emmett-Teller (BET) surface areas of the powders and composites of FIGS. 3A-3F, in accordance with certain embodiments of the disclosed technology.

FIG. 3I provides effective CO₂ uptakes of the composites of FIGS. 3A-3F calculated from CO₂ adsorption isobar at 1 bar recorded between 30° C. and desorption temperatures with constant temperature ramping of 0.5° C./min, in accordance with certain embodiments of the disclosed technology.

FIGS. 4A-4I provide SEM images of (A-B) zeolite 13X/CA, (D-E) mesoporous silica/CA, and (G-H) UiO-66(Zr)/CA, showing macroscopic wall structures (A, D, and G) and porous polymer matrix (B, E, and H), and SEM images of sorbent powders of (C) zeolite 13X, (F) silica, and (I) UiO-66(Zr) used for fabricating the composites, in accordance with certain embodiments of the disclosed technology.

FIGS. 5A-5I provide SEM images of (A-B) ZIF-8/CA, (D-E) AC/CA, and (G-H) HKUST-1/CA, showing macroscopic wall structures (A, D, and G) and porous polymer matrix (B, E, and H), and SEM images of sorbent powders of (C) ZIF-8, (F) AC, and (I) HKUST-1 used for fabricating the composites, in accordance with certain embodiments of the disclosed technology.

FIGS. 6A-6F illustrate nitrogen adsorption isotherms at 77 K of powder and composite materials from (A) zeolite 13X, (B) mesoporous silica, (C) UiO-66(Zr), (D) ZIF-8, (E) AC, and (F) HKUST-1, in accordance with certain embodiments of the disclosed technology.

FIGS. 7A-7B provide schematic illustrations of systems for (A) pressure drop measurement and (B) humid breakthrough experiment, in accordance with certain embodiments of the disclosed technology.

FIG. 8 illustrates design details of the gyroid cylinder used for fabricating silica/CA contactor for PEI impregnation and CO₂ adsorption and breakthrough experiments, in accordance with certain embodiments of the disclosed technology.

FIG. 9 provides a schematic illustration of poly(ethylenimine) (PEI) diffusion for the fiber (or cylindrical) and film (or wall) geometries, in accordance with certain embodiments of the disclosed technology.

FIG. 10 illustrates a setup of dry and humid dynamic breakthrough experiments conducted using a contactor module, in accordance with certain embodiments of the disclosed technology.

FIGS. 11A-11D illustrate the use of the contactor module of FIG. 10 in obtaining (A) pressure drops of the PEI/silica/CA gyroid contactor and those of fiber-packed columns; (B) outlet concentration profile from the dynamic breakthrough analysis of PEI/silica/CA gyroid contactor under 400 ppm CO₂/balance N₂ mixture at 43% relative humidity (RH); (C) comparison of breakthrough (C/C₀=0.05) and pseudo-equilibrium (C/C₀=0.95) capacities in various superficial velocities; and (D) combined index of pressure drop and mass transport in gyroid and fiber-packed columns, in accordance with certain embodiments of the disclosed technology.

FIGS. 12A-12B provide photographic (A) and SEM (B) images of a diamine 2-(aminomethyl) piperidine (2-ampd) impregnated Mg₂dobpdc/CA (dobpdc=4,4′-dioxidobiphenyl-3,3′-dicarboxylate) composite in gyroid shape fabricated by TPI, in accordance with certain embodiments of the disclosed technology.

FIGS. 13A-13C provide images of an amine-impregnated Mg₂dobpdc/CA composite prepared by a post-impregnating procedure, in accordance with certain embodiments of the disclosed technology.

FIGS. 14A-14E illustrate a Mg₂dobpdc/CA gyroid cylinder fabricated by TPI method with various weight loadings of Mg₂dobpdc, in accordance with certain embodiments of the disclosed technology.

FIGS. 15A-15B provide adsorption and desorption isobars for pure CO₂ of prepared 2-ampd/Mg₂dobpdc/CA composite, in accordance with certain embodiments of the disclosed technology.

FIGS. 16A-16B provide an image (A) and a photograph (B) of a 2-ampd/Mg₂dobpdc/CA gyroid composite with non-identical channel sizes, in accordance with certain embodiments of the disclosed technology.

FIG. 17A provides an illustration of an exemplary heat-integrated TPMS structure, in accordance with certain embodiments of the disclosed technology.

FIG. 17B provides a cross-sectional view of the heat-integrated TPMS structure of FIG. 17A, in accordance with certain embodiments of the disclosed technology.

FIG. 17C provides a cross-sectional view of the heat-integrated TPMS structure of FIG. 17A, in accordance with certain embodiments of the disclosed technology.

FIG. 17D provides a top view of the heat-integrated TPMS structure of FIG. 17A, in accordance with certain embodiments of the disclosed technology.

FIG. 18 is a flowchart of an example method of making a sorbent-based contactor, in accordance with certain embodiments of the disclosed technology.

FIG. 19 is a flowchart of an example method of making a contactor for use in a separation process, in accordance with certain embodiments of the disclosed technology.

### DETAILED DESCRIPTION

To increase efficiency and lower the cost of DAC following industrial demands, it is vital to structure DAC sorbents into macroscopic geometries with efficient mass and heat transport. As such, embodiments of the present invention suggest that TPMS is a promising candidate geometry for DAC due to its outperforming heat and mass transport. However, a novel method for structuring sorbents is required since the geometries are not achievable via traditional ways, e.g., injection molding. Non-solvent-induced phase separation (NIPS) of polymeric ink containing sorbent filler is a way to construct sorbent contactors with excellent mass transport. However, the macroscopic shapes from the NIPS have traditionally been limited to simple geometries.

In view of the above-mentioned challenges, embodiments of the present invention utilize TPMS shaped contactors for carbon capture. These TPMS shapes may include, for example, a gyroid, a Schwarz diamond, a Schwarz primitive, a Schoen I-WP, a Fischer Koch S, a split P, a Neovius, a lidinoid, etc. TPMS is a periodic 3D implicit surface with zero mean curvature, which has been derived for local area-minimizing. Since the mean curvature is zero at any point on a TPMS, fluid conceptually can flow in any direction, thus reducing gas mass transport resistance and pressure drop. In addition, TPMS has a high surface area per unit volume. For example, a gyroid TPMS has 3000 m²/m³ of surface area with a periodic length of 1 mm. The high surface area provides efficient heat exchange across the channels. For example, the TPMS contactors discussed herein can be used for conducting carbon capture by directing air, combustion gas, or refinery gas through a first channel of the contactor, and directing either a heating or cooling fluid though a second and non-intersecting channel, as further discussed below. TPMS also creates complex flow patterns, which further increase mass and heat transfer efficiency.

Embodiments of the present invention also provide a method for structuring sorbents into the TPMS shapes. The sorbents may include, for example, a zeolite (e.g., zeolite 13X), mesoporous silica, activated carbon (AC), a metal organic framework (MOF) (e.g., UiO-66(Zr), ZIF-8, HKUST-1), an amine appended MOF (e.g., Mg₂dobpdc), a carbon nanotube, alumina, a metal oxide, a hydroxide, a covalent organic framework (COF), an ion exchange resin, an amine functionalized support material, or combinations thereof. Due to the controllability of the macroscopic shape of polymers, incorporating sorbents in porous polymers is a promising method for preparing sorbent contactors.

Non-solvent-induced phase separation of polymeric ink containing sorbent filler is one way to construct the sorbent/polymer composite. In NIPS, a homogeneous ternary solution of polymer, solvent, and non-solvent is submerged into a coagulation bath containing a non-solvent, and the polymer precipitates out and forms a porous network. The macropores of the porous network facilitate gas transport to the sorbent.

### System and Process of the Present Disclosure

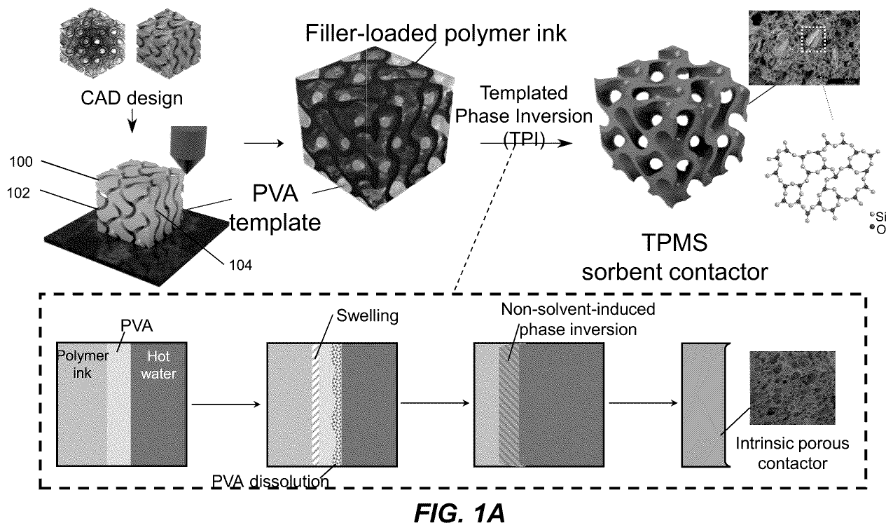

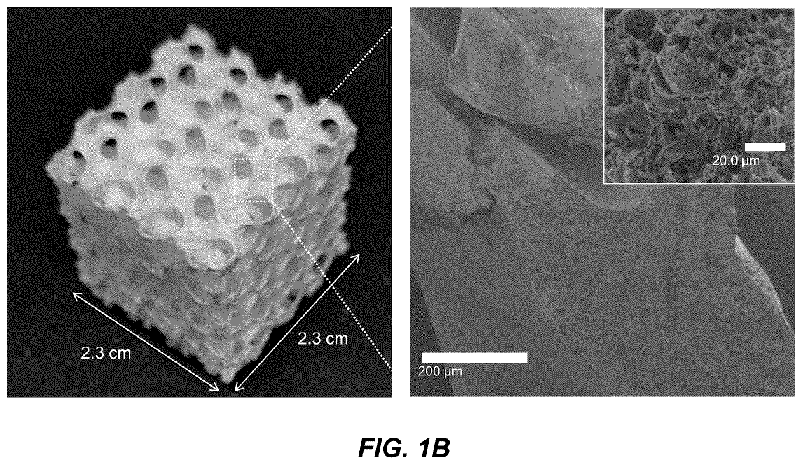

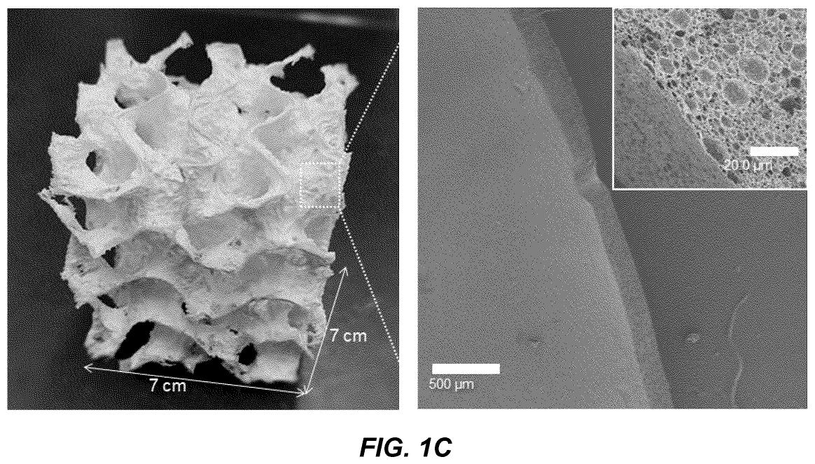

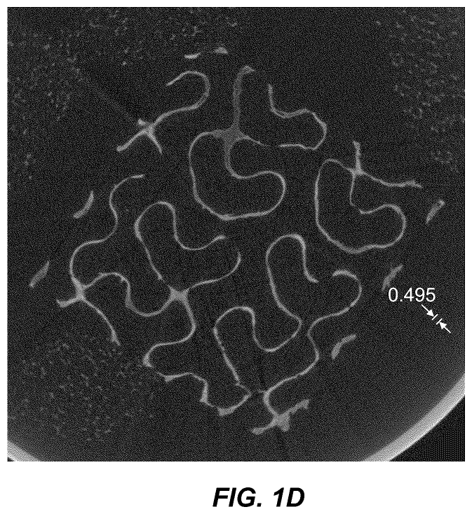

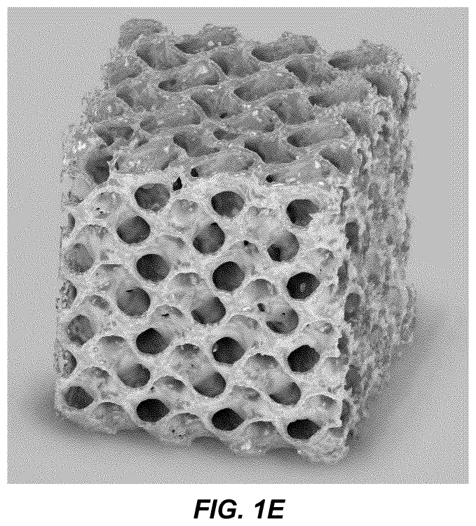

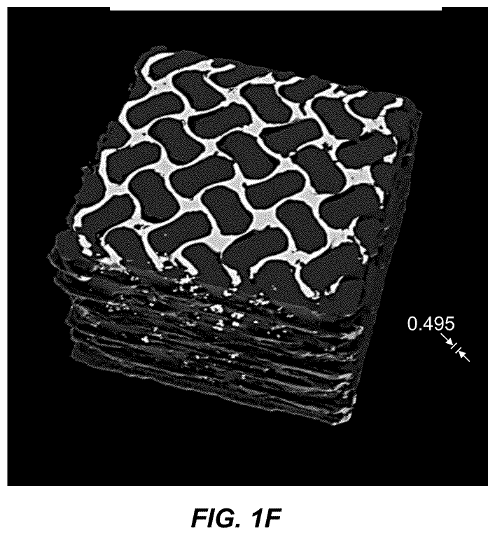

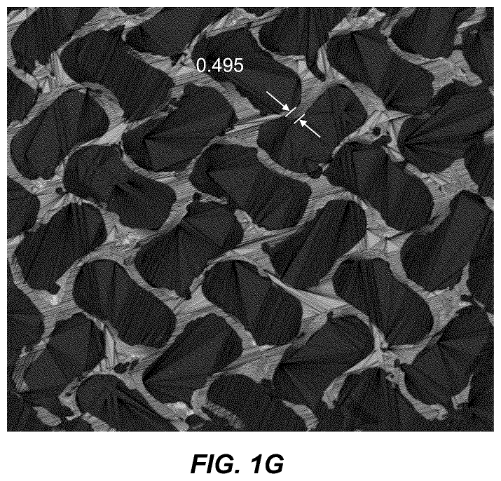

Embodiments of the present invention utilize NIPS of an adsorbent-loaded ternary polymeric ink within a 3D-printed template while dissolving the template in a solvent, such as water. In some embodiments of the present invention, the template may include, e.g., PVA, butenediol vinyl alcohol (BVOH), a High Impact Polystyrene (HIPS), etc. FIG. 1A illustrates a procedure to construct a TPMS-shaped sorbent contactor involving a 3D-printing technique and TPI. As shown, a template with a void 100 for introducing polymeric ink is first designed by a CAD program. In some embodiments, the void 100 is a single, continuous void. In other embodiments, the void 100 includes a first channel 102, and a second channel 104 that does not intersect the first channel. As further discussed below, the template is designed such that it has a reverse structure, or a 3D negative, for the target geometry of the resulting sorbent-based contactor. The TPMS templates may be generated by first selecting a TPMS pattern (e.g., a gyroid pattern), and assigning a thickness (e.g., between approximately 0.1 mm and 1 mm) to the TPMS pattern to generate the 3D template. The template is closed with walls but has an entrance and exit to allow for flow of injected polymeric inks without significant pressurization. The template is printed via commercial FDM printers and water-soluble polymer filaments. Homogeneous ternary and water-soluble polymeric inks are injected into the template and immersed in hot water to dissolve the template and initiate NIPS of the polymeric ink within the template simultaneously.

Embodiments of the present invention use a polymer-based ink with various additive sorbents for injection into the printed template. In some embodiments, the polymer-based ink may include, for example, polyvinylpyrrolidone (PVP), cellulose acetate (CA), N-methyl-2-pyrrolidone (NMP), water, polyimide, polyethersulfone (PES), or combinations thereof. In some embodiments, the sorbent may include, for example, zeolite 13X, mesoporous silica, AC, and/or a metal organic framework (MOF) (e.g., UiO-66(Zr), ZIF-8, and/or HKUST-1). Specifically, the polymer inks with additive sorbents are injected into a void within the template. The templates are then immersed in a coagulant bath with hot water, dissolving the template and phase-inverting the ink inside simultaneously to generate the sorbent-based contactor having at least two non-intersecting channels. In some embodiments, the templates are immersed in the hot water bath for a time period, with the hot water being replaced at least once during that time period. In some embodiments, the time period may be between approximately 15 minutes and approximately three hours, between approximately 30 minutes and approximately two hours, or between approximately 45 minutes and approximately one hour. In some embodiments, the time period may be at least approximately 15 minutes, at least approximately 30 minutes, at least approximately 45 minutes, at least approximately one hour, at least approximately two hours, or at least approximately three hours. The resulting contactor may have up to an amount of the sorbent relative to the contactor. In some embodiments, the amount of the sorbent relative to the contactor may be between approximately 5 wt % and approximately 80 wt %, between approximately 15 wt % and approximately 65 wt %, or between approximately 25 wt % and approximately 50 wt %. In some embodiments, the amount of the sorbent relative to the contactor may be at least approximately 25 wt %, at least approximately 35 wt %, at least approximately 45 wt %, at least approximately 55 wt %, at least approximately 65 wt %, or at least approximately 75 wt %.

SEM, micro-CT, and nitrogen adsorption experiments are used to probe the microscopic porosities and macroscopic geometries of the resulting TPMS-shaped composites. Gas accessibility to sorbents inside the composites is examined by observing gas adsorption and desorption behavior under pure CO₂ flow. Finally, a gyroid-shaped sorbent contactor for DAC is prepared by impregnating PEI into the silica/CA composite. The CO₂ capture performance of the PEI/silica/CA gyroid contactor from simulated air in both dry and humid conditions is investigated. The results present the first examination of self-supported TPMS sorbent contactors for CO₂ capture, and the novel technique can be applied to fabricate numerous combinations of active material and geometry.

### EXAMPLES

TPMS Prepared with Different Sizes

The viability of TPI was evaluated first by constructing simple geometries, including a short cylinder and plate. CA ink was prepared using a dope composition for spinning sorbent fiber contactors, as shown in Table 1.

TABLE 1

| Target contactor | Material | Concentration (wt %) |
|---|---|---|
| CA | CA | 11.65 |
| | PVP | 4.67 |
| | NMP | 74.11 |
| | DI Water | 9.57 |
| Silica/CA (45 wt %) | SiO₂ (C803) | 8.70 |
| | CA | 10.63 |
| | PVP | 4.27 |
| | NMP | 67.67 |
| | DI water | 8.73 |
| Silica/CA (50 wt %) | SiO₂ (C803) | 10.39 |
| | CA | 10.39 |
| | PVP | 4.59 |
| | NMP | 66.10 |
| | DI water | 8.53 |
| Zeolite 13X/CA, AC/CA, UiO- | Adsorbent | 10.43 |
| 66/CA, HKUST-1/CA | CA | 10.43 |
| | PVP | 4.19 |
| | NMP | 66.38 |
| | DI water | 8.57 |
| ZIF-8/CA | ZIF-8 | 9.74 |
| | CA | 9.74 |
| | PVP | 3.91 |
| | NMP | 68.61 |
| | DI water | 8.00 |

After injecting the ink into the templates, the templates were immersed in hot water (e.g., about 55° C.). After 12 hours of submerging and exchanging the hot water at least three times, PVA templates were fully removed, and CA solidified into cylinder and plate shapes. SEM images revealed well-defined pores in the solidified CA, suggesting that rapid phase inversion occurred for the CA ink.

The overall shapes of the porous Cas from the TPI were observed to be consistent with the CAD drawings, although the porous Cas were found to have smaller characteristic lengths and wall thicknesses than originally designed. The inventors found the origin of this wall thickness reduction phenomena is due to PVA swelling occurring upon contact with the polymeric ink.

The capability of the TPI method for constructing porous polymer architectures with complex 3D geometries was demonstrated with CA in a gyroid cube configuration, as shown in FIG. 1B. The cube had a side length of 23 mm and was filled by a gyroid pattern with a unit cell size of 6.2 mm and with a wall thickness of 0.62 mm. The gyroid wall was constructed by solidifying the iso-surfaces defined by Equation 1, below.

$$Sin x cos y + sin y cos z + sin z cos x = 0. \qquad Equation ( 1 )$$

In spite of the more complex geometry compared to a simple plate or fiber, the TPI method was able to construct unexpectedly precise gyroid architectures. The CA gyroid cube prepared by TPI had a good intrinsic porosity inside the wall of around 500 μm thickness, as observed via SEM imaging. The agreement between the initial design and the final composite architecture was examined through micro-CT (FIGS. 1D-1G). In this technique, an x-ray scans images of a target object layer-by-layer, from which 3D models are constructed. Similarly, the 3D model of the PVA template, which was used for fabricating the CA gyroid cube, was prepared. The initial CAD and the 3D-printed PVA template coincide with each other well, with small deviance in minor details due to the limit of the nozzle size (about 0.4 mm) and layer height (about 0.06 mm) of the FDM printer. The 3D model of the template was also compared with that of the resulting CA gyroid cube. The template size was reduced by about 13.9% to compensate for the overall shrinkage of the CA. As a result, the two models fit each other well, as shown in FIGS. 1F-1G, demonstrating that TPI can produce contactors with geometries that coincide with the CAD of the template. The average wall thickness evaluated by the micro-CT is about 495 μm, which is about 20% thinner than the initial design.

One crucial requirement of a fabrication process for sorbent contactors is the ability to produce contactors at the large scales that the industry requires. A key aspect of the TPI mechanism exhibited above is that it does not limit the scale of the contactor. If phase inversion in TPI occurred from the open entrance of the template and propagated, it would be highly limited by the distance from the entrance and diffusion. However, in the TPI mechanism of the present invention, polymeric inks maintain homogeneity until they meet non-solvents after the dissolution of PVA template walls. Therefore, as long as non-solvents can dissolve the PVA quickly enough, the TPI could fabricate a contactor with a larger size.

A larger CA gyroid cube with a side length of about 70 mm was fabricated through TPI to examine the potential to scale up, as shown in FIG. 1C. For both the reduction of template printing time and the fast introduction of water into the template, the template for the large gyroid cube was printed with zero infills for the volume inside the walls. The zero-infill printing creates voids within the template walls (i.e., 100% infill is completely solid walls), which provides a fast pathway for the water. The resulting CA was found to be porous with a macroscopic gyroid architecture. This suggests that as long as a suitable wall thickness range is maintained, the TPI has no currently known limitations for producing a larger sorbent contactor that meets industrial demands.

TPMS Prepared with Different Shapes

The capability of TPI for fabricating sorbent contactors with various TPMS shapes was examined with zeolite 13X and UiO-66(Zr) sorbents. The sorbents were added to the CA inks so that the resultant sorbent loading was about 50 wt % of the total contactor, as provided above in Table 1. This is significantly higher sorbent loadings than previous attempts based on coating 3D printed scaffolds. Even with high sorbent loadings, TPI of the zeolite 13X/CA and UiO-66(Zr)/CA inks produced porous sorbent contactors with gyroid, Schwarz diamond, and Schwarz primitive patterns.

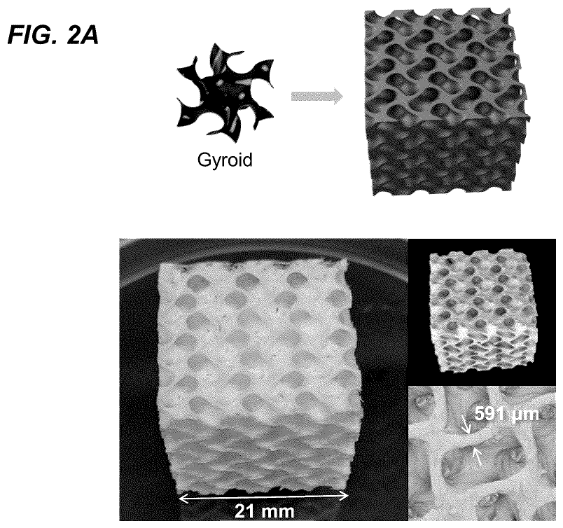

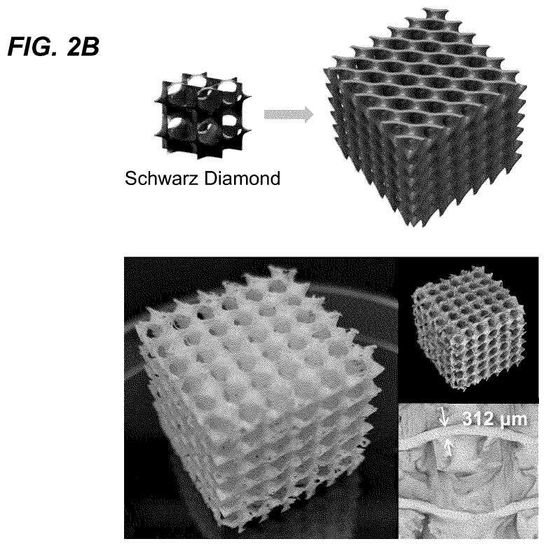

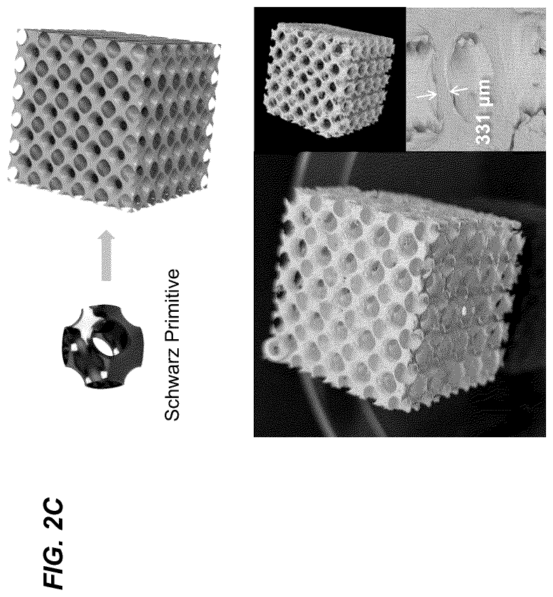

FIGS. 2A-2C illustrate UiO-66(Zr)/CA sorbent contactors in various TPMS shapes. Images of TPMS in a single unit cell and an expanded cubic 3D geometry of the gyroid (a), Schwarz diamond (b), and Schwarz primitive (c) are shown along the top, while respective photographic and micro-CT-based 3D images of the same are shown along the bottom. One significant improvement in the contactor with the sorbents is lesser shrinkage and wall thickness reduction compared to those without sorbents, as shown below in Table 2.

TABLE 2

| | Overall size | | | | | |
|---|---|---|---|---|---|---|
| | (length of a side) | | | Wall thickness | | |
| | Designed | Resulted | Discrepancy | Designed | Resulted | Discrepancy |
| | (mm) | (mm) | (%) | (μm) | (μm) | (%) |
| CA gyroid cube | 23 | 19.8 | 13.9 | 620 | 495 | 20.2 |
| UiO-66(Zr)/CA | 23 | 21.9 | 4.8 | 620 | 591 | 4.7 |
| gyroid cube | | | | | | |
| UiO-66(Zr)/CA | 23 | 21.7 | 5.7 | 330 | 312 | 5.5 |
| diamond cube | | | | | | |
| UiO-66(Zr)/CA | 23 | 21.7 | 5.7 | 350 | 331 | 5.4 |
| primitive cube | | | | | | |

In the case of UiO-66(Zr)/CA gyroid, the overall shrinkage in the cube was only about 4.8%, significantly less than the about 13.9% in the CA gyroid. This suggests that the shrinking during drying is primarily caused by the CA, and the lower contents of CA in the sorbent/CA gyroid therefore reduce the shrinking effect. The degree of swelling of PVA in the presence of sorbent was examined using PVA filament and the zeolite 13X/CA ink, and the result coincides with the observation in sorbent/CA gyroid cubes.
TPMS Prepared with Different Sorbent Composites

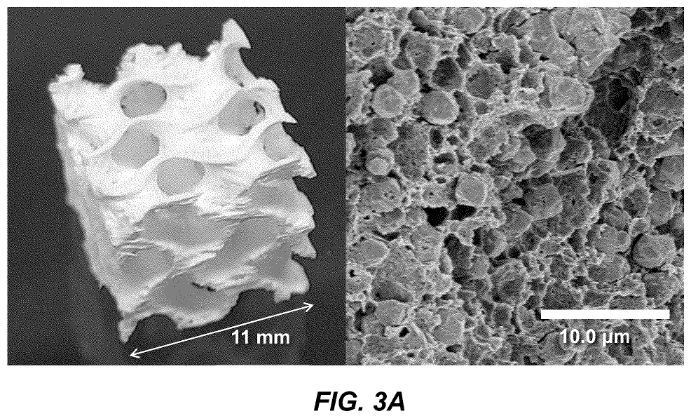

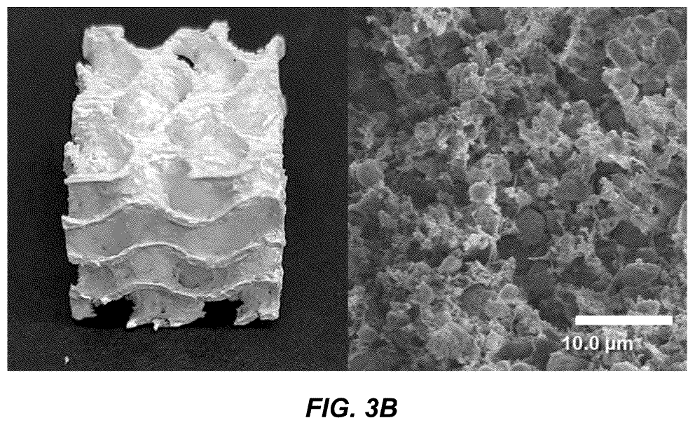

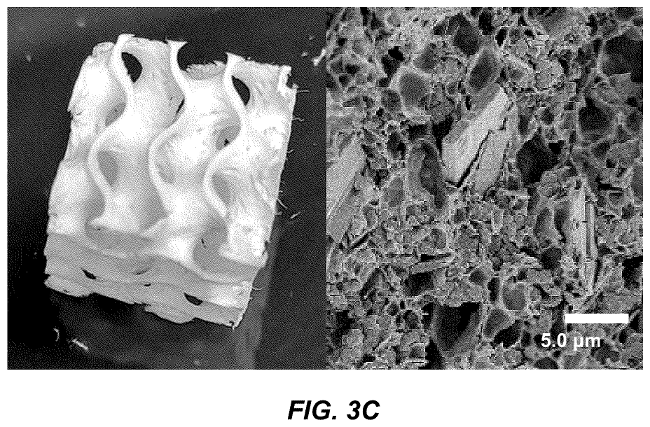

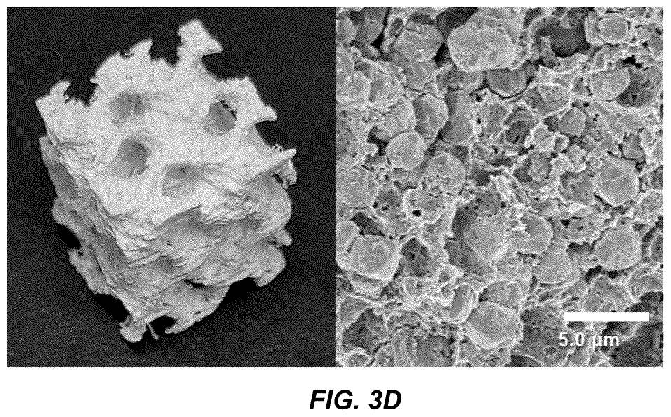

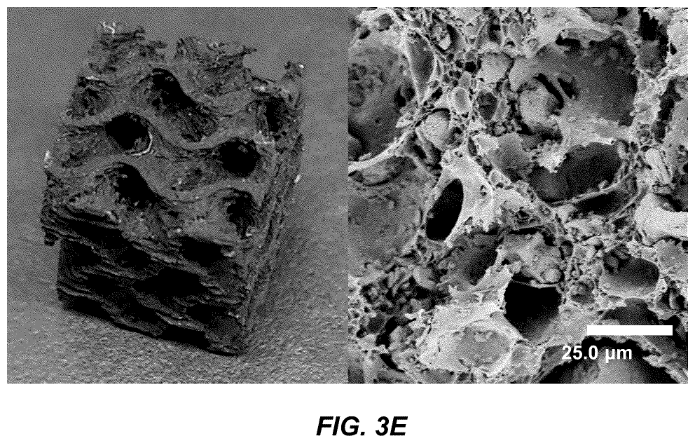

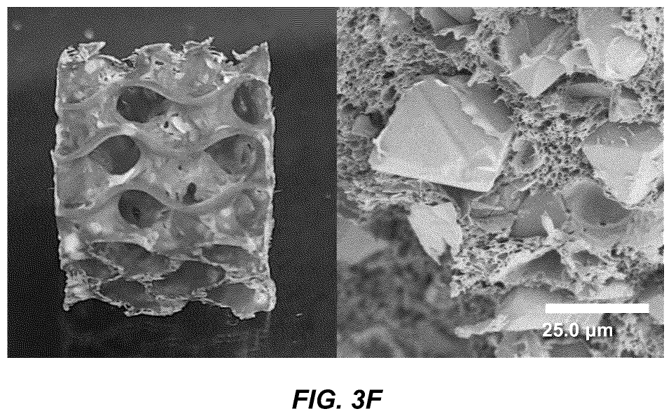

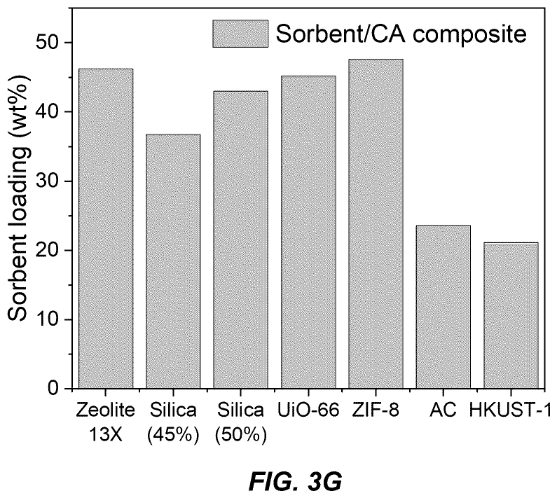

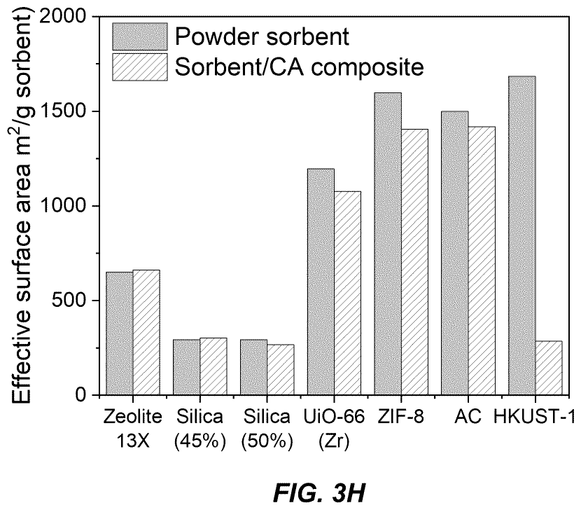

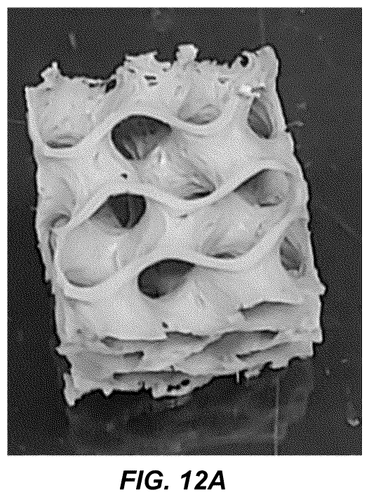

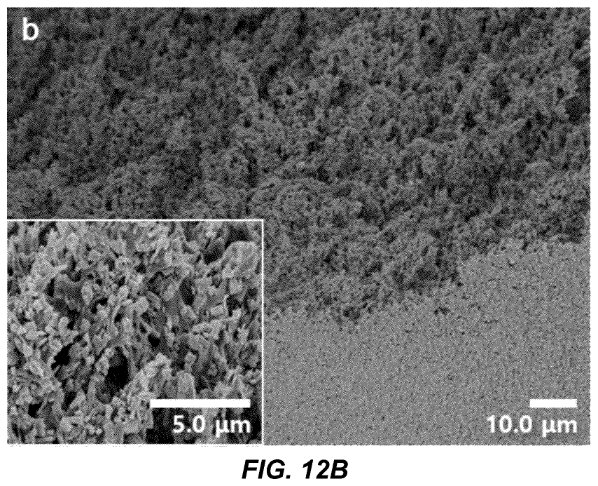

One merit of the TPI method is its relatively mild stimuli for sorbents rather than pelletizing or fiber spinning. TPI requires less mechanical stability of sorbents than fiber spinning or solution-based additive manufacturing, where pressure is applied to the sorbent to extrude it through a nozzle. The requirement for TPI can be summarized as the stability of sorbents in solvent, non-solvent, air, and water. Because there are fewer constraints on the sorbent, the TPI method is likely to be compatible with a variety of sorbents. To verify the compatibility of TPI, the method was applied to construct gyroid cubes with various sorbents, such as zeolite 13X, mesoporous silica, AC, and three kinds of MOFs, UiO-66(Zr), ZIF-8, and HKUST-1, as illustrated in FIGS. 3A-3I, 4A-4I, and 5A-5I, as well as amine appended MOF, Mg₂dobpdc, as illustrated in FIGS. 12A-12B, 13A-13C, 14A-14E, 15A-15B, and 16A-16B.

FIGS. 3A-3F provide data associated with gyroid sorbent contactors with various sorbents, and specifically photographic and SEM images of small (a) zeolite 13X/CA, (b) silica/CA, (c) UiO-66(Zr)/CA, (d) ZIF-8/CA, (e) activated carbon/CA, and (f) HKUST-1/CA composites in gyroid shapes. FIG. 3G provides sorbent loading (wt %) in the composites calculated from the decomposition under air. FIG. 3H provides BET surface areas of the powders and the composites calculated from 77 K N₂ adsorption experiment. Finally, FIG. 3I illustrates effective CO₂ uptakes calculated from CO₂ adsorption isobar at 1 bar recorded between 30° C. and desorption temperatures with constant temperature ramping of 0.5° C./min. The weighted average of CO₂ uptakes of sorbents and CA was used to predict the CO₂ uptakes of the resulting composites.

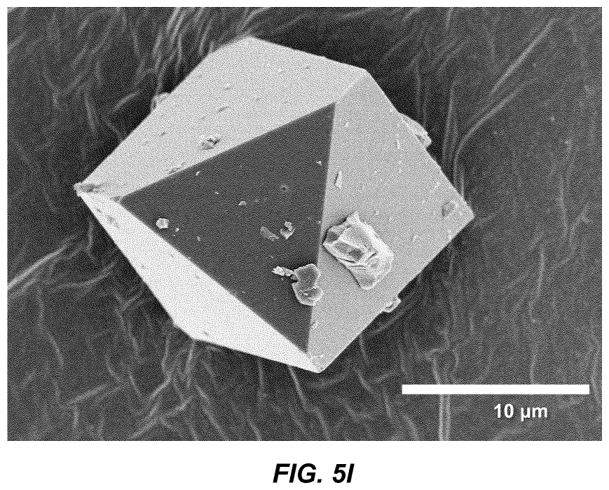

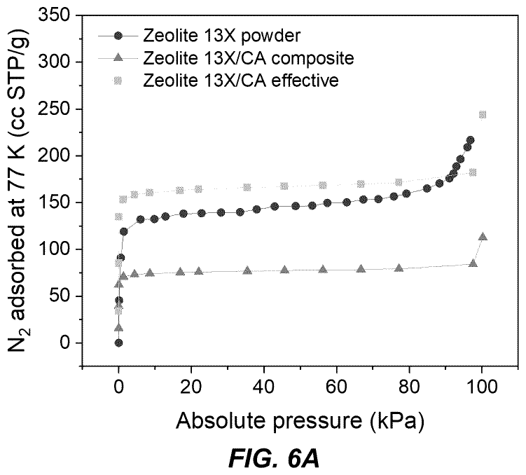

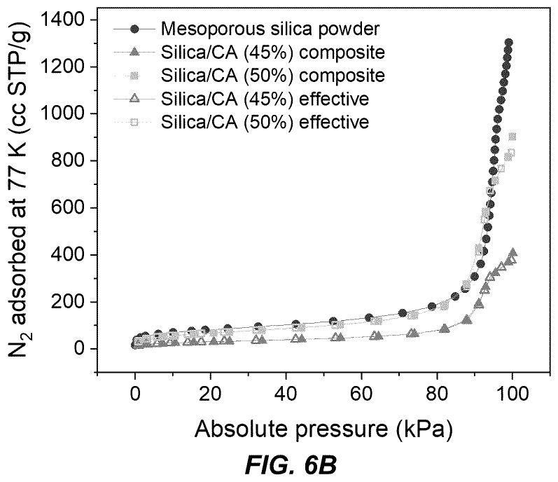

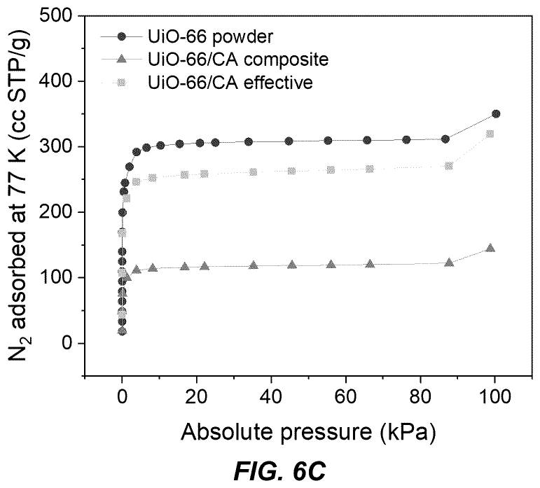

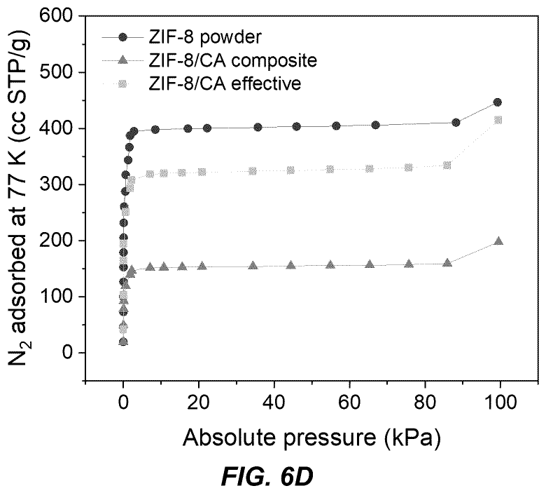

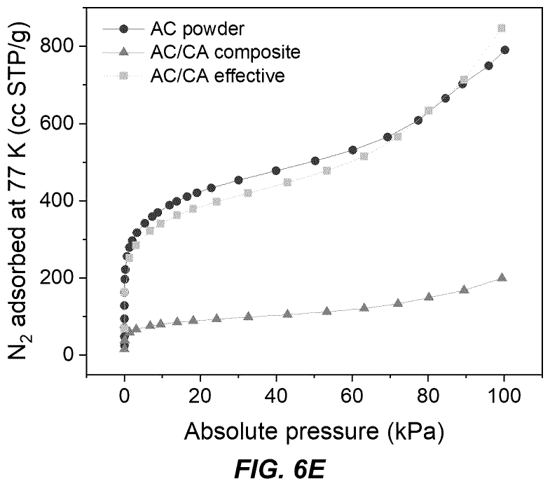

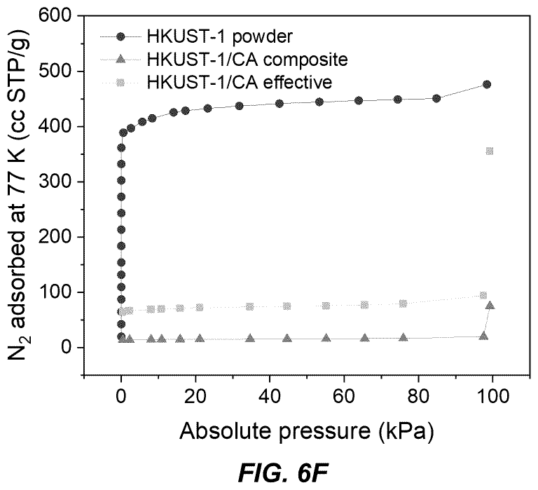

Nitrogen adsorption of the sorbent/CA composites at 77 K showed that the surface area of the composites coincides well with the predicted surface area from the sorbent loading, as shown in FIGS. 3H and 6A-6F, indicating that the open pore structure of the polymer support can transport nitrogen to the sorbents well without significant pore blocking. FIGS. 6A-6F show nitrogen adsorption isotherms at 77 K of powder and composite materials from (a) zeolite 13X, (b) mesoporous silica, (c) UiO-66(Zr), (d) ZIF-8, (e) AC, and (f) HKUST-1. The effective uptakes represent the N₂ uptakes per gram sorbent in the composite. HKUST-1, however, due to its low stability in water, was decomposed during the TPI process and yielded a low BET surface area (about 60 m²/g) of HKUST-1/CA. At last, the CO₂ uptakes of the composites at 1 bar and 30° C. matched well with the predicted uptakes from the sorbent loading, as shown in FIG. 3I, which shows the promise of the TPI for CO₂ capture.

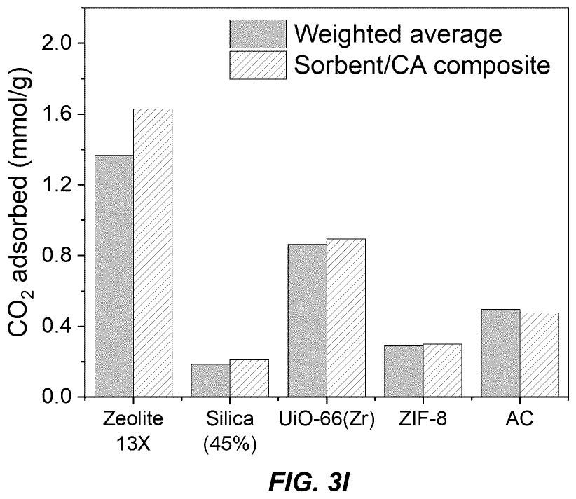

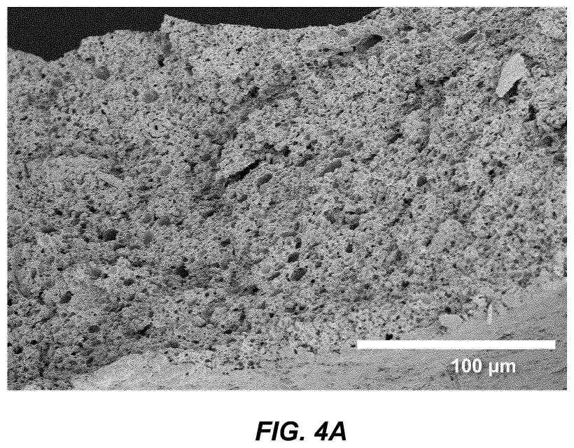

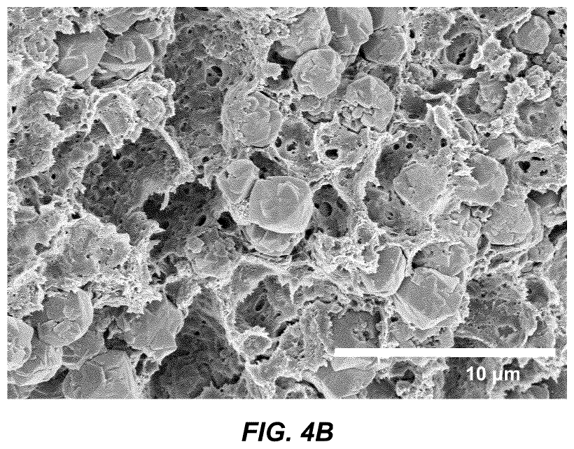

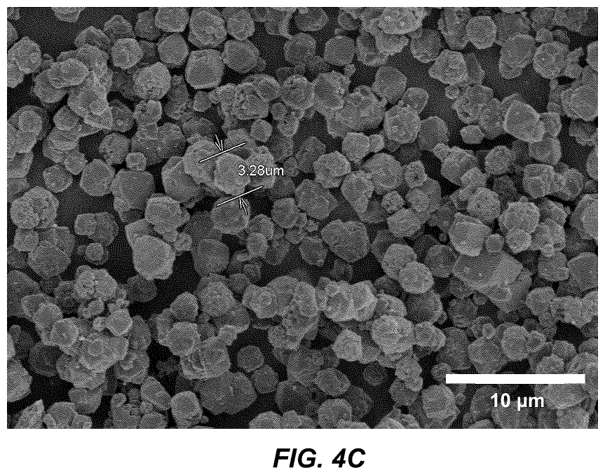

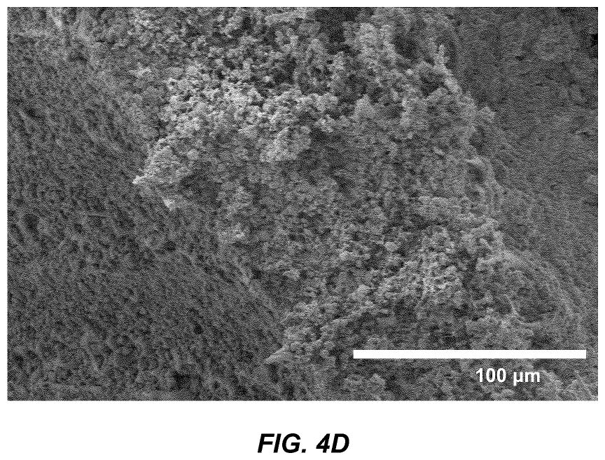

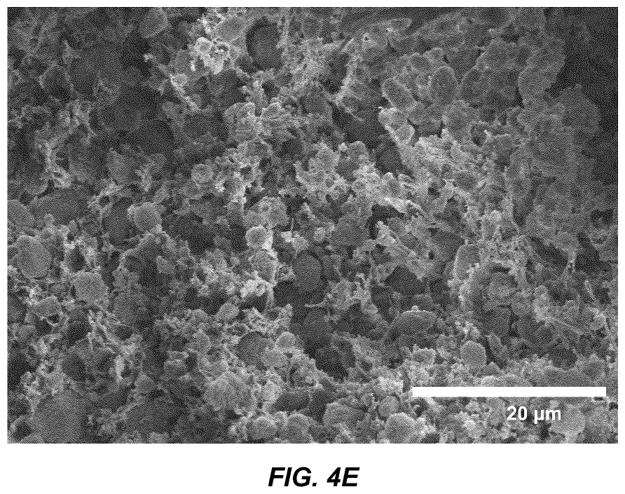

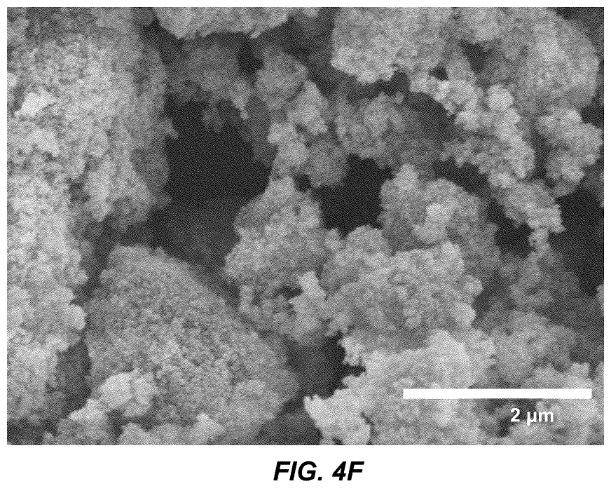

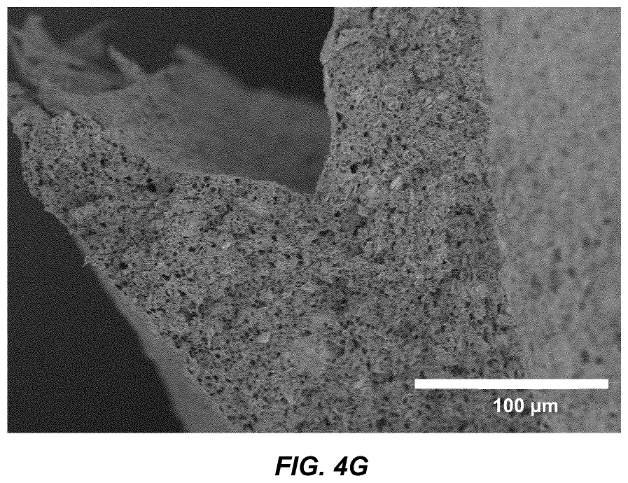

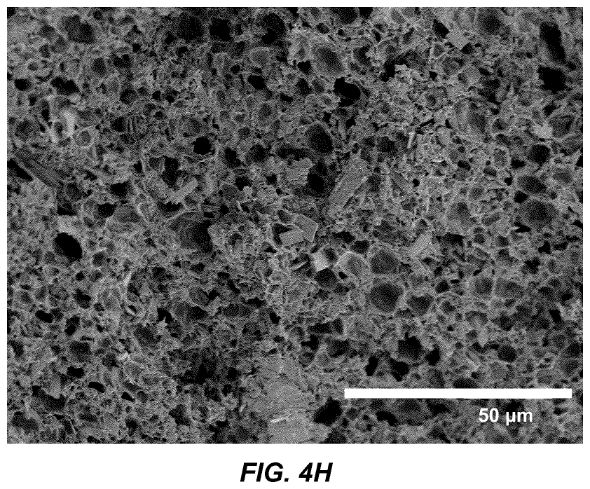

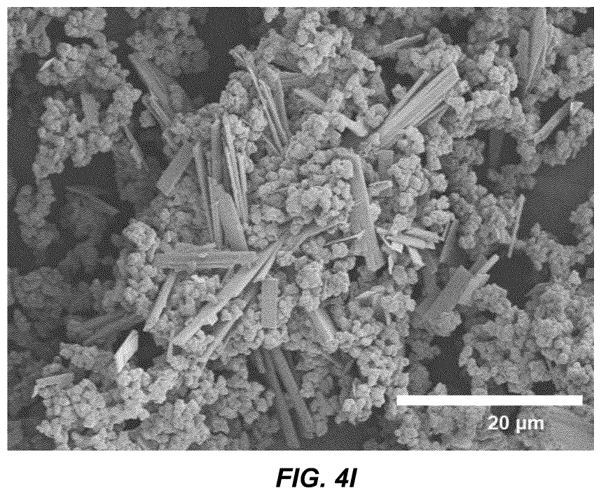

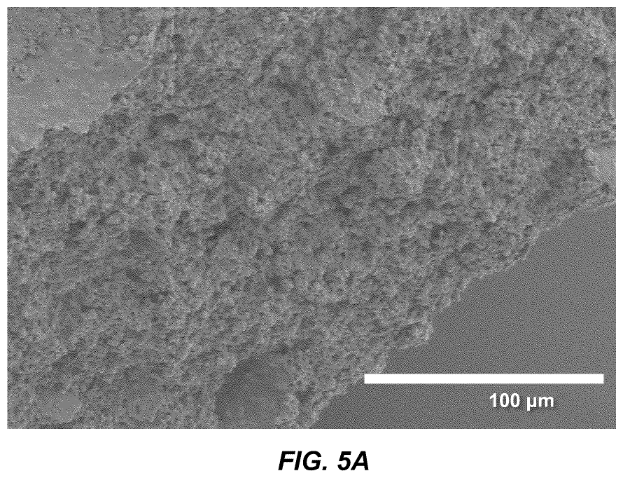

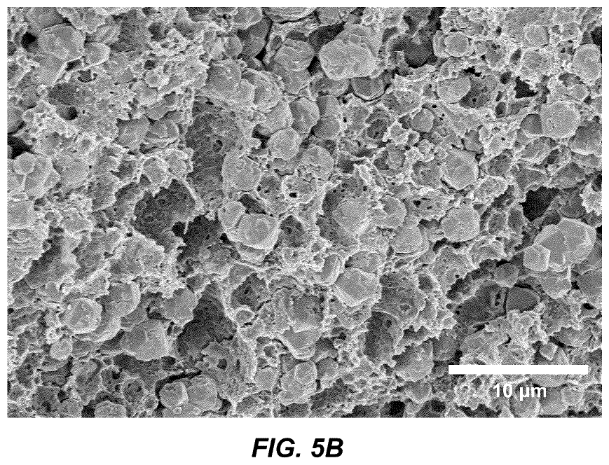

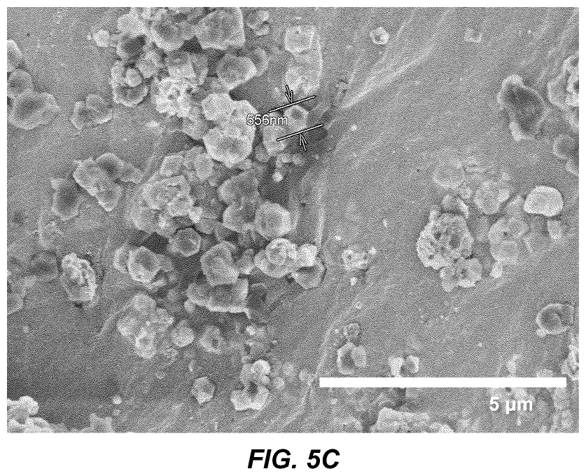

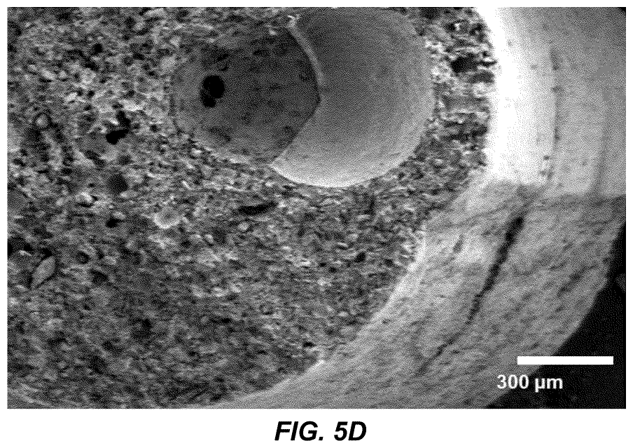

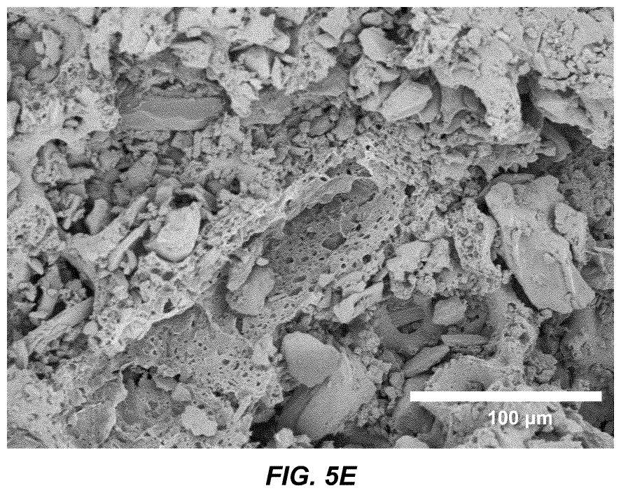

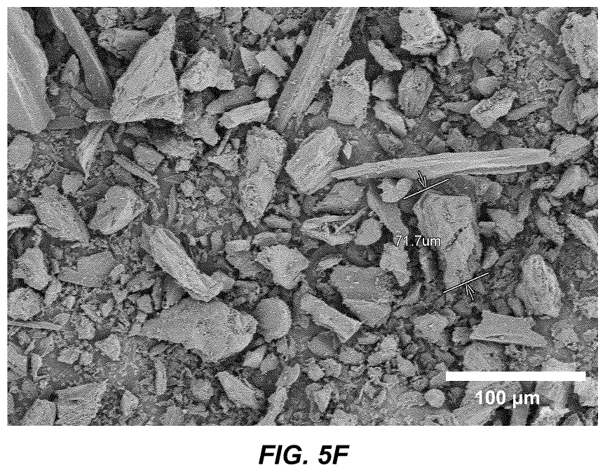

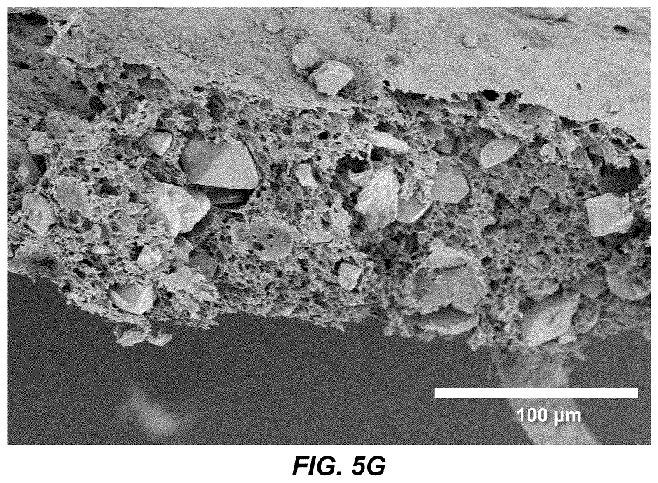

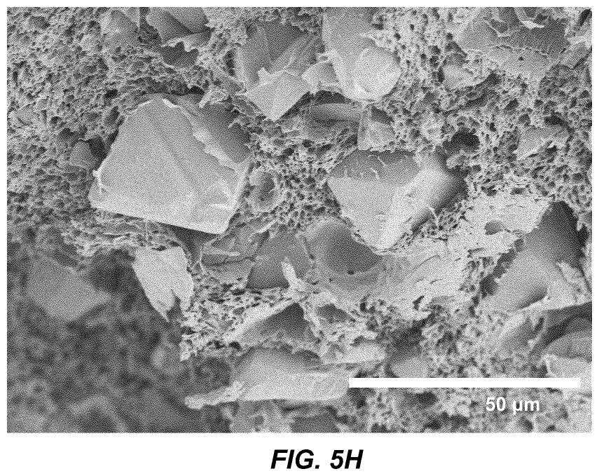

FIGS. 4A-4I provide SEM images of (A-B) zeolite 13X/CA, (D-E) mesoporous silica/CA, and (G-H) UiO-66(Zr)/CA, showing macroscopic wall structures (A, D, and G) and porous polymer matrix (B, E, and H), and SEM images of sorbent powders of (C) zeolite 13X, (F) silica, and (I) UiO-66(Zr) used for fabricating the composites. FIGS. 5A-5I provide SEM images of (A-B) ZIF-8/CA, (D-E) AC/CA, and (G-H) HKUST-1/CA, showing macroscopic wall structures (A, D, and G) and porous polymer matrix (B, E, and H), and SEM images of sorbent powders of (C) ZIF-8, (F) AC, and (I) HKUST-1 used for fabricating the composites.

The inks of most sorbents could be prepared simply by adding degassed sorbents into the dope solution used for CA without the fillers. However, ZIF-8 required additional NMP to form a homogeneous polymeric ink, likely because the hydrophobic ZIF-8 adsorbs NMP selectively from the solution, which breaks the balance of solvents and non-solvents in the ternary ink. TPI of the inks resulted in composites with well-defined porosity and macroscopic gyroid architectures. Most resulting composites had reasonable sorbent loading between about 37 wt % and about 48 wt % except for AC and HKUST-1, as shown in FIG. 3G. Large particles (e.g., from about 20 μm to about 50 μm) of AC and HKUST-1 may have caused non-homogeneous mixing and lower weight loading in the resulting composites, as shown in FIGS. 5A-5I.

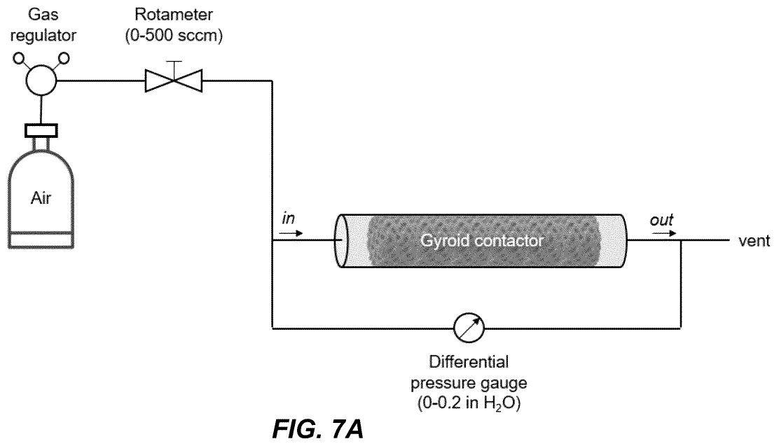

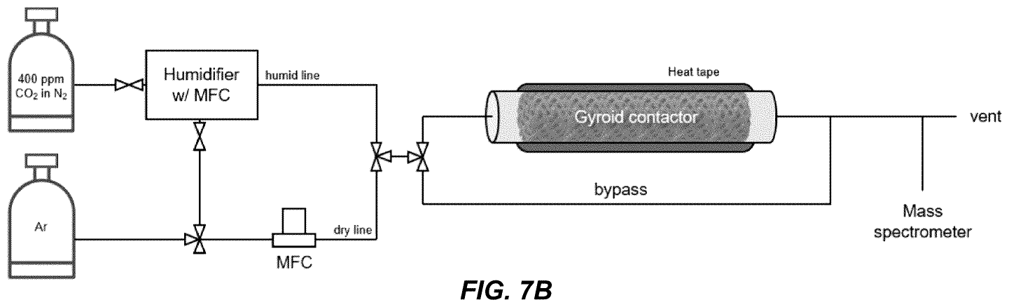

Based on the above results, a TPMS contactor for DAC was prepared by impregnating PEI into mesoporous silica and CA composite. Before the impregnation, a silica/CA gyroid cylinder was designed and fabricated for further use in cylindrical tubes for fixed bed experiments. FIGS. 7A-7B provide schematic illustrations of the systems used for (A) pressure drop measurement and (B) humid breakthrough experiment. The gyroid cylinder was designed to have as many unit cells as possible to maximize the benefits of the geometry. As shown in FIG. 8, a PVA template was generated as a 3D negative of the shape of the target contactor. Also, its macroscopic void fraction was minimized to about 41%, which is comparable with pellet-packing beds. The average wall thickness was set as about 745 μm with gas channels of around 900 μm between the walls. The loading of the silica in the composite was also maximized up to about 43 wt % by increasing silica contents in the polymeric ink up to silica:CA=1:1.

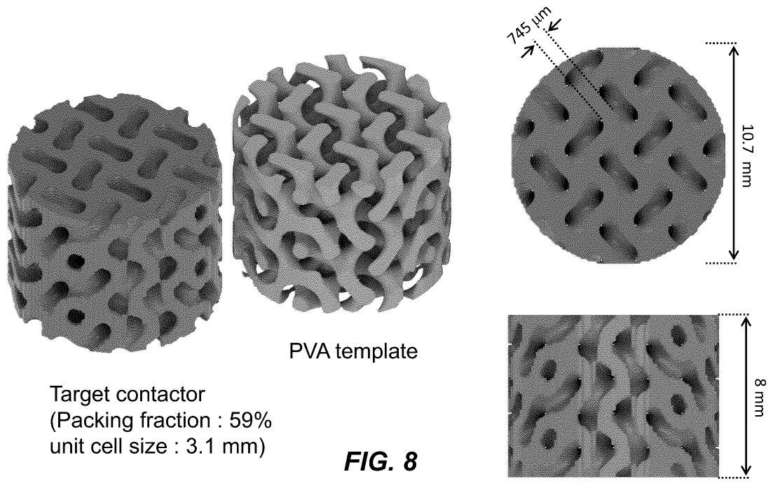

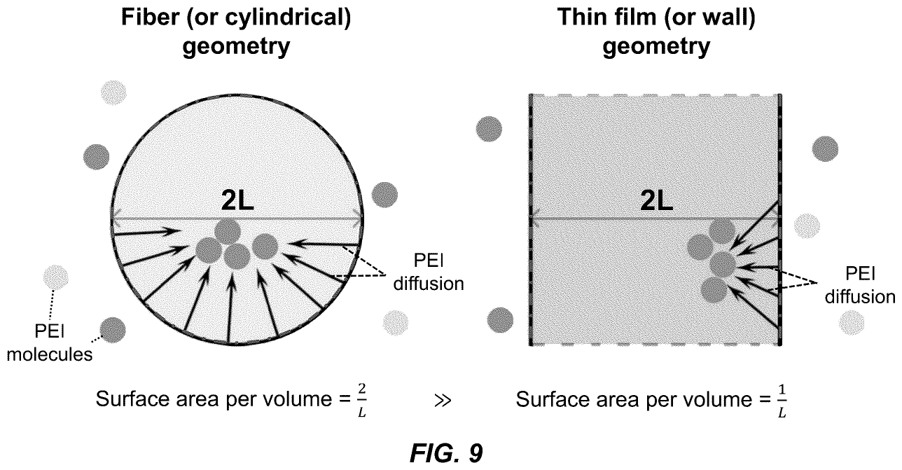

At least an about 17.5 wt % of PEI in methanol solution was used for impregnating more than 0.1 g PEI/g silica in the gyroid cylinder. To impregnate 0.64 g PEI/g silica, which is comparable with the optimal PEI loading of 0.7 g PEI/g silica in fibers, silica/CA gyroid cylinders were immersed in about 22.5% PEI/methanol solution overnight. These infusion conditions differ from those of fiber-based contactors, which may be due to the local geometry of the gyroid composite being close to the plane wall, and that of the fiber is the cylinder. The plane wall geometry has a lower surface-to-volume ratio and is less approachable by diffusion from the outside compared to the cylindrical geometry, as shown in FIG. 9.

The success of the impregnation of PEI to make a DAC contactor was shown by dilute CO₂ adsorption experiments under a modified TGA instrument and a volumetric apparatus. Under constant flow of dry 400 ppm CO₂/N₂ at 30° C., the PEI/silica/CA gyroid contactor had an uptake of about 0.67 mmol CO₂/g contactor at pseudo-equilibrium, slightly higher than the reported uptake (about 0.63 mmol/g contactor at 35° C.) for the PEI/silica/CA fiber. The high CO₂ uptakes of the gyroid contactor were also confirmed by a volumetric adsorption experiment, in which the CO₂ uptake at 30° C. and 40 Pa was about 0.71 mmol/g contactor.

The humid CO₂ adsorption of the PEI/silica/CA gyroid contactor recorded on a TGA exhibited that CO₂ uptakes of the contactor increased to about 1.1 mmol CO₂/g contactor under a pseudo-equilibrium. The PEI/silica/CA gyroid contactor did not exhibit any noticeable amine leaching or degradation during seven cycles of adsorption and desorption of water and CO₂ by temperature swing between 30° C. and 110° C. under a continuous flow of 400 ppm CO₂/N₂ mixture with 50% RH.

FIGS. 12A-12B, 13A-13C, 14A-14E, 15A-15B, and 16A-16B are illustrative of an amine appended MOF/CA TPMS contactor fabricated by TPI. FIGS. 12A-12B provide photographic (A) and SEM (B) images of diamine 2-(aminomethyl) piperidine (2-ampd) impregnated Mg₂dobpdc/CA (dobpdc=4,4′-dioxidobiphenyl-3,3′-dicarboxylate) composite in gyroid shape fabricated by TPI. 2-ampd was first impregnated into Mg₂dobpdc, and the 2-ampd@Mg₂dobpdc/CA composite was fabricated following the TPI method.

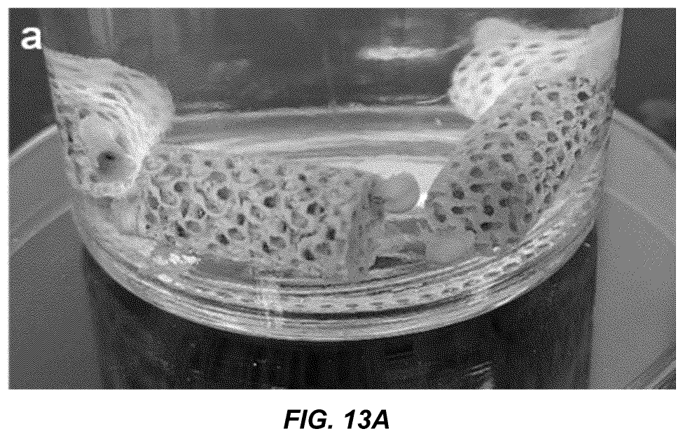

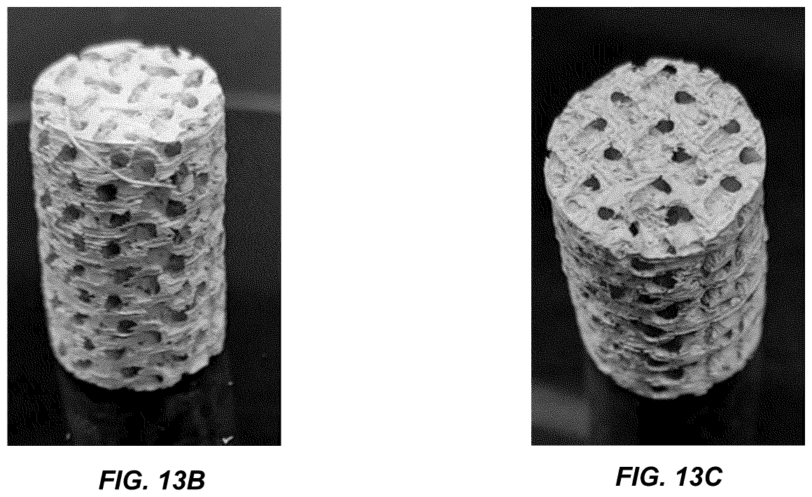

FIGS. 13A-13C provide images of an amine-impregnated Mg₂dobpdc/CA composite prepared by a post-impregnating procedure. FIG. 13A shows a Mg₂dobpdc/CA (31.9 wt % of Mg₂dobpdc) gyroid cylinder fabricated by TPI method. FIG. 13B shows an N,N′-dimethylethylenediamine (mmen) impregnated Mg₂dobpdc/CA gyroid cylinder. FIG. 13C shows a 2-ampd impregnated Mg₂dobpdc/CA gyroid cylinder.

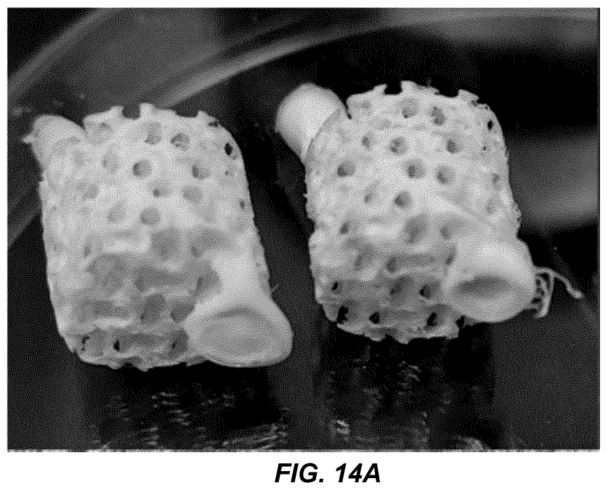

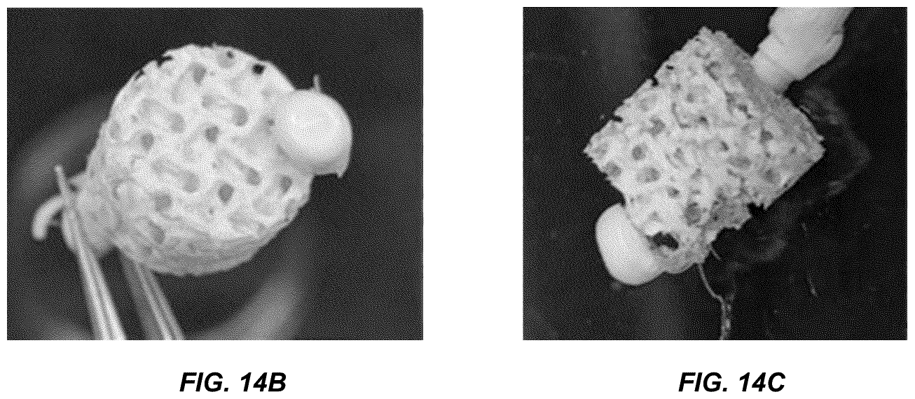

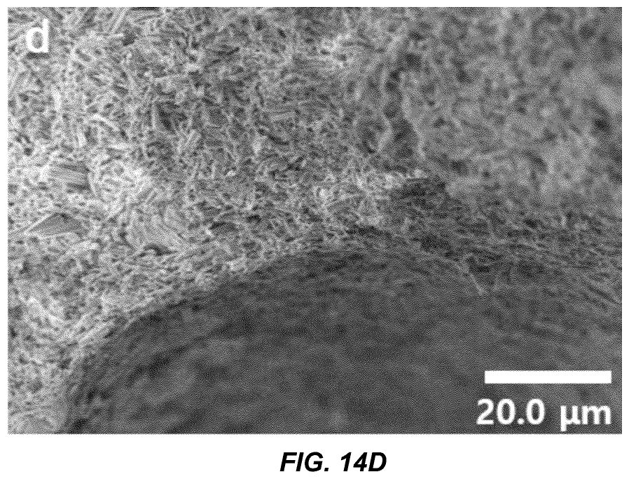

FIGS. 14A-14E illustrate a Mg₂dobpdc/CA gyroid cylinder fabricated by TPI method with various weight loadings of Mg₂dobpdc. FIG. 14A illustrates a 50 wt % (left) and 60 wt % (right) loading; FIG. 14B illustrates a 70 wt % loading; FIG. 14C illustrates a 75 wt % loading. FIGS. 14D-14E provide SEM images of Mg₂dobpdc/CA at a 50 wt % loading (D) and 70 wt % loading (E)

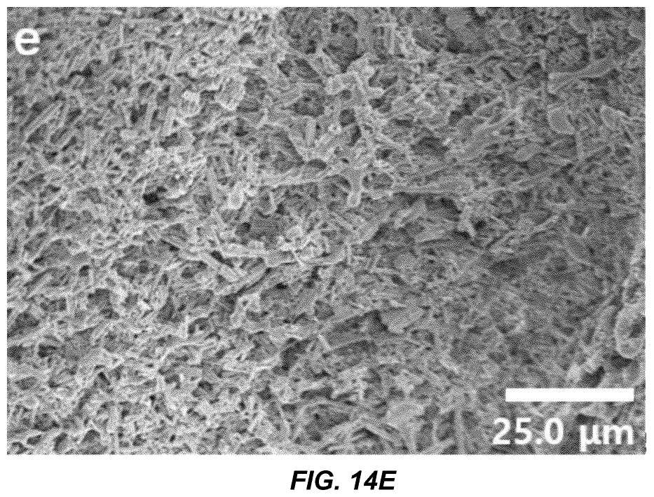

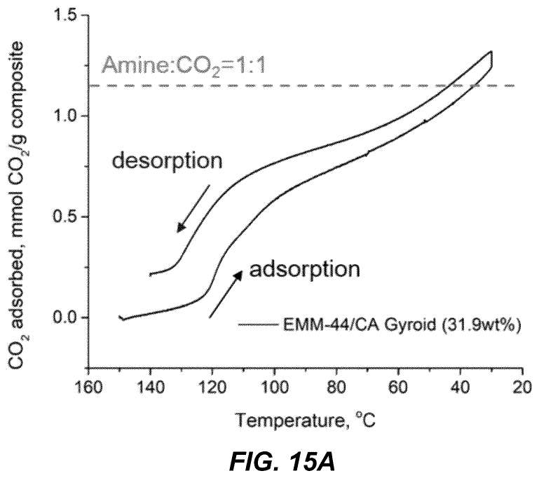

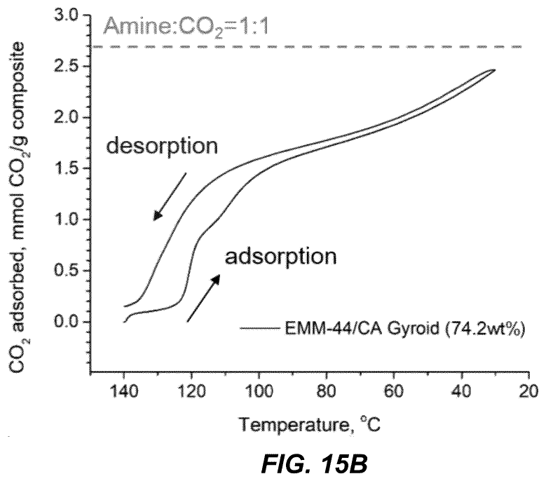

FIGS. 15A-15B provide adsorption and desorption isobars for pure CO₂ of prepared 2-ampd/Mg₂dobpdc/CA composite with the ramping rate of 0.5° C./min with the Mg₂dobpdc/CA gyroid having a 31.9 wt % loading (A) and 74.2 wt % loading (B).

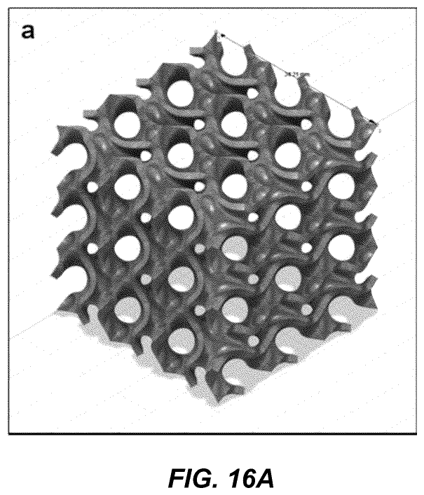

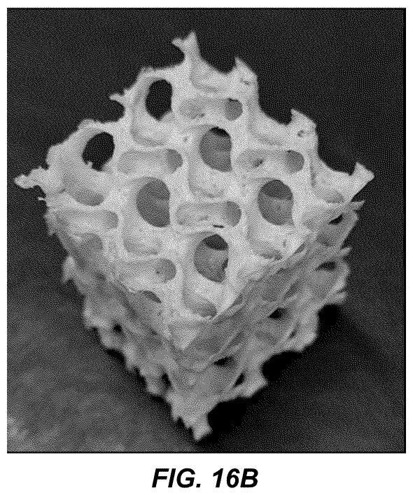

FIGS. 16A-16B provide a generated image (A) and a photograph (B) of a 2-ampd/Mg₂dobpdc/CA gyroid composite with non-identical channel sizes.

### Higher Performance of TPMS Contactors

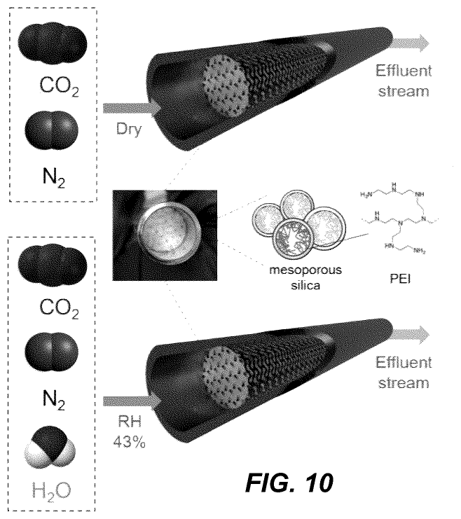

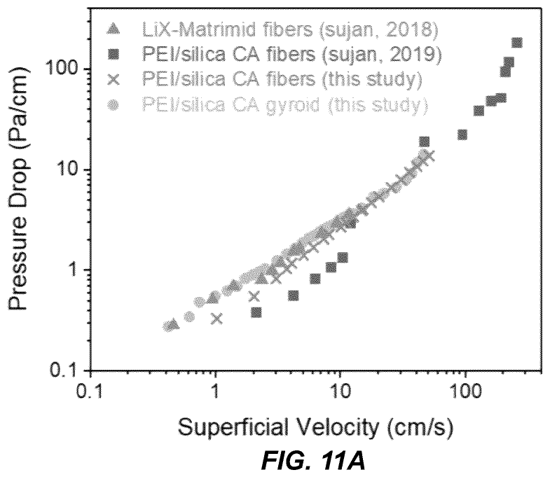

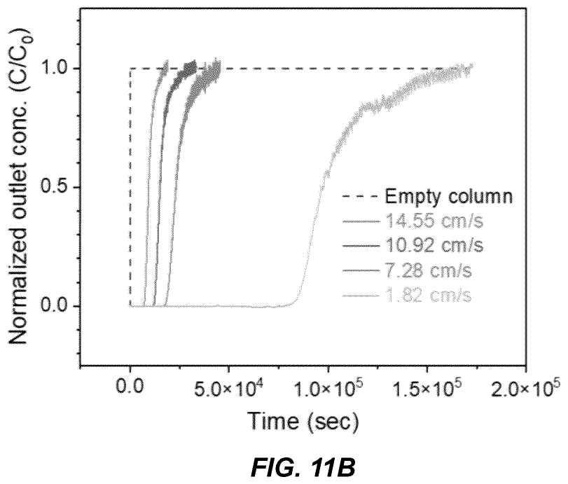

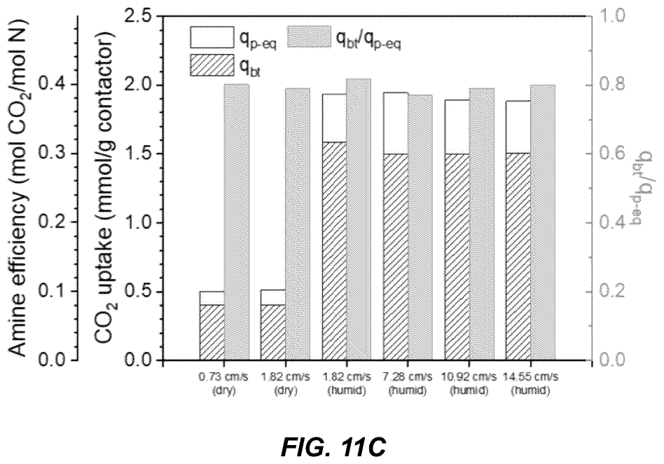

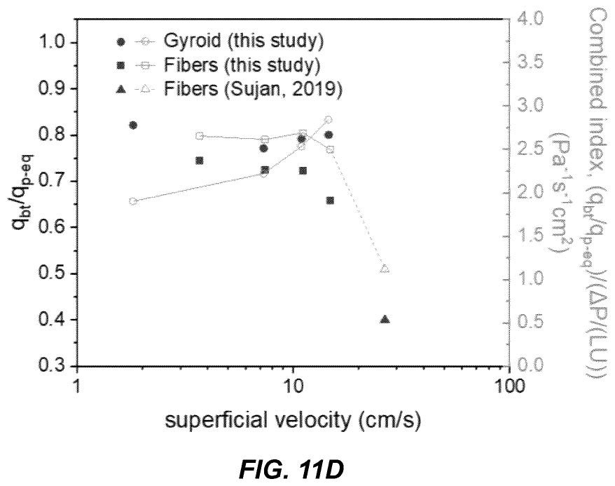

Dynamic breakthrough experiments were conducted using a contactor module built by packing eleven PEI/silica/CA gyroid cylinders in ½ inch (outer diameter, OD) stainless steel pipe, as illustrated in FIG. 10. The effective length of the contactor was about 9 cm, and the dry weight was about 1.5 g. TPMS generates complex turbulent flow, as further discussed below, and is expected to have a disadvantage in pressure drop. Nevertheless, the gyroid contactor fabricated from TPI exhibited a comparable pressure drop with that of fiber-packed columns, especially at high superficial velocity (e.g., greater than about 10 cm/s), as shown in FIG. 11A.

Before the breakthrough experiments were run, as discussed below, the pressure drop of the contactor was tested under a custom-built system by flowing N₂ gas at 25° C. across the contactor. Even with the lower void faction, the pressure drop of the gyroid contactor was smaller than that of a bead- or pellet-packed column and comparable to fiber-packed columns. In some embodiments, the pressure drop of the gyroid contactor was between approximately 5 to 50 times smaller than that of a bead- or pellet-packed column (e.g., approximately 10 times smaller, approximately 20 times smaller, approximately 30 times smaller, approximately 40 times smaller, etc.), between approximately 10 to 40 times smaller, between approximately 15 to 30 times smaller, between approximately 20 to 25 times smaller, etc. At 100 standard cubic centimeters per minute (sccm) (about 1.92 cm/s superficial velocity), the flow rate used in the following breakthrough experiment, the pressure drop of the gyroid contactor was almost negligible (about 0.8 Pa/cm).

Breakthrough experiments were run with dry and humid (e.g., about 43% RH) simulated air, as shown in FIG. 11B. In dry 400 ppm CO₂ at 35° C., the pseudo-equilibrium capacity (q_{p-eq}, C/C₀=0.95) of the gyroid module was about 0.51 mmol/g contactor, which is similar to the CO₂ uptakes measure in other apparatus, as shown in FIG. 11C. Compared to the fiber module (about 0.61 mmol/g contactor), the gyroid module had a slightly lower pseudo-equilibrium capacity per gram contactor, but higher capacity per gram PEI in the module (about 2.317 mmol/g PEI), suggesting that the lower pseudo-equilibrium capacity is mainly due to the lower loading of silica (about 43 wt %) in the contactor. At both about 40 sccm (about 0.73 cm/s in superficial velocity) and about 100 sccm (about 1.82 cm/s in superficial velocity) of total feed flow rate, the ratio of breakthrough capacity (q_{bt}, C/C₀=0.05) to pseudo-equilibrium capacity (about 0.802) was similar with that of the fiber module (about 0.837) in dry conditions. This is because in the PEI-involved system, CO₂ adsorption is usually internally limited by PEI itself, and the difference in macroscopic geometry of the contactor does not significantly influence mass transport.

The presence of humid vapor, however, could reduce this internal limitation, and the role of geometry could become significant. FIG. 11C illustrates how the presence of water vapor largely improved CO₂ capacity while maintaining good mass transfer. At 100 sccm of total feed flow rate, the q_{bt} and q_{p-eq} of the gyroid contactor were about 1.584 and about 1.93 mmol/g contactor, respectively. The gyroid also had significant CO₂ capacity per gram of PEI (about 8.96 mmol/g) in humid conditions, corresponding to an increased amine efficiency of about 0.386 mol CO₂ per mol N, compared to other contactors.

The merit of the geometry of the TPMS-shaped sorbent contactor was exhibited by comparing it with fiber-packed columns, as shown in FIG. 11D. The gyroid module maintained a high q_{bt}/q_{p-eq} (about 0.818) under 50% RH and 100 sccm flow rate in contrast with the fiber module. The PEI/silica/CA fiber-packed column showed a significant decrease in its q_{bt}/q_{p-eq} at high superficial velocity (q_{bt}/q_{p-eq}=0.658 at 14.83 cm/s) of 400 ppm CO₂/N₂ (43% RH). In the fiber module, increasing the flow rate to 90 sccm under dry conditions decreased the q_{bt}/q_{p-eq} to about 0.710. The ratio further decreased to about 0.412 under humid conditions and a higher flow rate (about 200 sccm). This data shows that significant mass transport limitations exist in the fiber modules. In contrast, mass transport limitations appear minimal in the gyroid as the contactor maintained its q_{bt}/q_{p-eq} around 0.79+0.03 at high superficial velocities (up to about 15 cm/s).

The above-described mass transport improvements may also be due to the high turbulent mixing energy that is characteristic of a TPMS geometry. A combined index is proposed, as provided below in Equation 2, that takes into account the ratio of breakthrough capacity to pseudo-equilibrium capacity, as well as pressure drop.

$$Combined index = ( \frac{brea kthrough capacity}{pseudo - equilibrium capacity} ) / Δ {P}_{reduced} = ( \frac{{q}_{bt}}{{q}_{p - eq}} ) / ( \frac{Δ P}{L \cdot U} ) , \qquad Equation ( 2 ) .$$

where ΔP_{reduced}, ΔP, L, and U are reduced pressure drop (Pa·s·cm⁻²), pressure drop (Pa), effective column length (cm), and superficial velocity (cm/s), respectively. The result shows that the fiber-packed module could be better at a low superficial velocity region (about ≤10 cm/s) due to lower pressure drop and similar q_{bt}/q_{p-eq}. However, the combined indices of the gyroid and fiber-packed contactors intersect at around 12 cm/s, and the performance of the gyroid contactor can surpass that of fibers at higher superficial velocity.

Desorption dynamics of the gyroid contactor were also examined. First, the CO₂ desorption profile of the PEI/silica/CA gyroid contactor was recorded after the humid breakthrough analysis at 100 sccm. The contactor was heated to 90° C. while flowing argon at 22 sccm. As a result, captured CO₂ during the humid breakthrough analysis was almost recovered (about 1.78 mmol/g contactor) after desorbing for 900 minutes. The difference between adsorption and desorption capacity may be due to slightly insufficient desorption temperature. The time required for recovering 90% of full desorption capacity was 400 minutes.

Prior to desorption, the gyroid contactor was exposed to a lab atmosphere at 21° C. overnight for CO₂ capture. The contactor was then desorbed by flowing argon at 72 sccm and heating the contactor to 110° C. Faster argon flow resulted in a smoother profile of CO₂ desorption rate than the previous experiment since the contactor could be heated more smoothly and more homogeneously. Due to the higher desorption temperature and adsorbent gas flow rate, the desorption speed was much faster. Within 110 minutes, the total desorbed CO₂ reached about 1.86 mmol/g contactor, which is approximately equal to the CO₂ pseudo-equilibrium capacity of the contactor recorded in a breakthrough analysis using humid simulated air. It took 79 minutes to desorb 90% of full desorption capacity.

Overall, the breakthrough results show TPI's capability in producing contactors for DAC, as well as the potential for enhanced mass transfer by using TPMS sorbent contactors in CO₂ capture technologies.

### Heat-Integrated TPMS Structure

The addition of implanting stainless-steel metal tubes into the template void was conducted to enable thermal management of the TPMS contactor for carbon capture, for example, through adsorption heat removal and/or rapid heat transport for heating and cooling. The metal tubes, serving as fluid channels for directing the heat transfer fluid (e.g., water), were inserted into the template void prior to injecting the polymer-based ink into the template void.

A TPMS contactor having a Schwarz diamond shape, as discussed herein, has a unique characteristic in that straight lines can be drawn along a longitudinal axis of the template structure and as passing through the inside of its walls. Metal tubes can be implanted along these straight lines to provide for fast heat removal (e.g., adsorption) and/or fast contactor heating, providing desorption enthalpy. Such tube implantation can also provide conductive heat transfer with minimal volume occupancy of the fluid channels, structural integrity of the monolithic structure, and/or improved mass and/or heat transfer merit of the TPMS contactor.

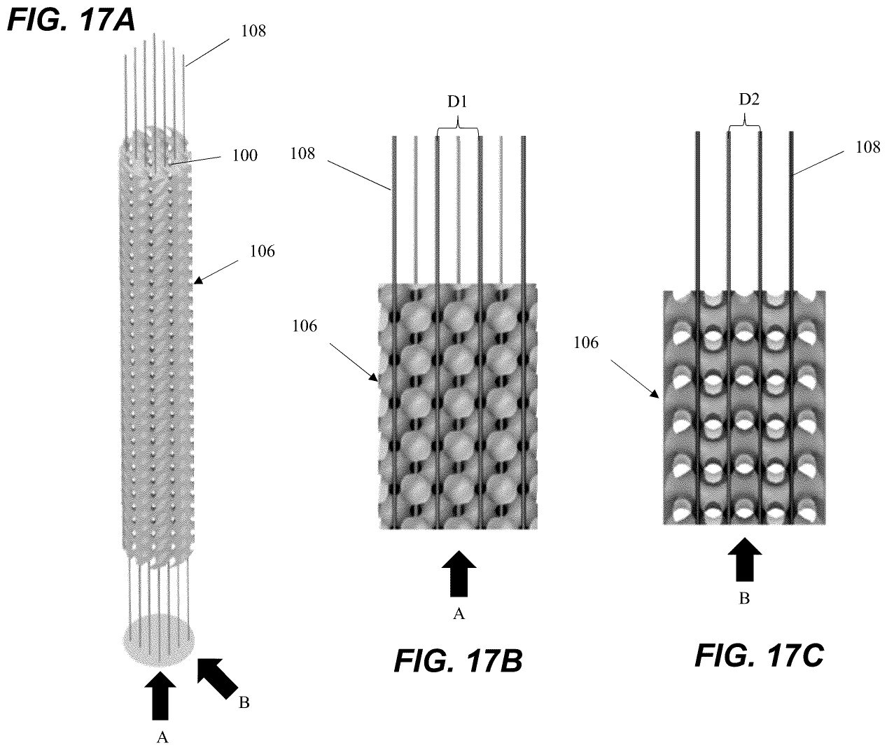

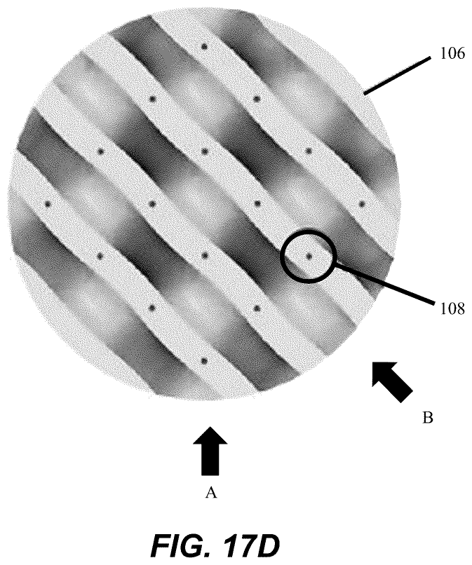

For example, as shown in FIGS. 17A-17D, a template 106 may be generated having a void 100, as discussed herein. One or more tubes 108 may be inserted into the void 100. As particularly shown in FIG. 17D, showing a top-down view of the template 106 with tubes 108, the tubes 108 may be aligned in a predefined pattern, such as a grid formation. In such grid formation, the alignment or pattern of the tube(s) 108 can be looked at from multiple directions, such as direction A and direction B. FIG. 17B provides a cross-section of the template 106 when looking in direction A, while FIG. 17B provides a cross-section of the template 106 when looking in direction B. The distances between adjacent tube(s) may depend on the diamond structure itself. As shown in FIG. 17B, for example, a distance D1 between adjacent tube(s) 108 can be between approximately 2.0 to 8.0 mm (e.g., 6.8 mm). As shown in FIG. 17C, for example, a distance D2 between adjacent tube(s) 108 can be between approximately 1.0 to 6.0 mm (e.g., 4.8 mm).

A first heat-integrated structure was fabricated. In the first heat-integrated structure, stainless steel tubes were implanted through the contactor template along the inside of the template void walls. After the tubes were implanted, epoxy was used to seal any gaps between each tube and the respective walls of the template void. A polymer-based ink (e.g., silica/CA) was then injected into the template void, and the template submerged in water to undergo TPI. A polytetrafluoroethylene (PTFE) tubing was used around the template structure. The resulting contactor was tested for structural stability via a gas leak test using a 4.5% CO₂ feed in humid condition.

It was found that water successfully passed through the tubing without significant pressure build up. It took 35 seconds for water to pass through the contactor at 120 mL/min with the void volume being approximately 70 milliliters (mL) and the tubing volume being approximately 2.49 mL. After amine impregnation and hexane washing, the gas channel was dried under N₂ flow at 40 standard cubic centimeters per minute (sccm) for approximately 7-12 hours.

The effect of cooling fluid on cooling speed of the contactor was tested. Starting at a contactor temperature of approximately 88° C. (with a heating tape temperature of approximately 110° C.), cooling was recorded while flowing dry N₂ at approximately 50 sccm. The inlet cooling temperature was maintained at approximately 25° C. with the flow rate at approximately 23.1 mL/min. For reaching approximately 60° C., the system including coolant was approximately 7.5 times faster in cooling speed. For reaching between approximately 50° C. to 40° C., the system including coolant was between approximately 3.6 to 2.8 times faster in cooling speed than an equivalent system without coolant. This effect of cooling fluid on cooling speed is unexpectedly significant considering the cooling channels, via the metal tubing, occupy only between approximately 0.6% to 0.7% (e.g., 0.64%) volume of the overall contactor system volume.

A first breakthrough analysis was conducted by flowing a dry 4.5% CO₂ feed with a He tracer and N₂ balance at approximately 30 sccm while circulating coolant at 25° C. The contactor exhibited a sharp breakthrough curve (at approximately 1.0 breakthrough concentration) after 5 hours of adsorption. When 2.0 grams of PEI loading on 1 gram silica was assumed, CO₂ uptake reached approximately 1.2 mmol/gram contactor in approximately 5 hours. When 1.2 grams of PEI loading on 1 gram silica was assumed, CO₂ uptake reached approximately 1.5 mmol/gram contactor in approximately 5 hours. When 0.7 grams of PEI loading on 1 gram silica was assumed, CO₂ uptake reached approximately 1.9 mmol/gram contactor in approximately 5 hours. These uptakes were higher than an expected uptake of approximately 1.1 mmol/gram.

A second breakthrough analysis was conducted by flowing a 4.5% CO₂ feed (at approximately 50% RH) with a He tracer and N₂ balance at approximately 200 sccm while circulating coolant at 25° C. Even at such higher flow rate, the contactor exhibited a sharp breakthrough curve (at approximately 1.0 breakthrough concentration) after approximately 45 min of adsorption. The CO₂ uptake was approximately 2.1 times larger than in the dry experiment, discussed above, and higher than expected. When 2.0 grams of PEI loading on 1 gram silica was assumed, CO₂ uptake reached approximately 2.5 mmol/gram contactor in approximately 45 min. When 1.2 grams of PEI loading on 1 gram silica was assumed, CO₂ uptake reached approximately 3.2 mmol/gram contactor in approximately 45 min. When 0.7 grams of PEI loading on 1 gram silica was assumed, CO₂ uptake reached approximately 4.0 mmol/gram contactor in approximately 45 min.

The effect of adsorption time on recovery was conducted in a humid system, measuring recovery (%) over a time period of between approximately 50 to 95 min. When full desorption was assumed, the adsorption process time could be reduced to approximately 48 minutes (recovery at approximately 90%).

A second heat-integrated structure was fabricated. As in the first heat-integrated structure, stainless steel tubes were implanted through the contactor template along the inside of the template void wall in fabricating the second heat-integrated structure.

A first breakthrough analysis was conducted by flowing a 4.5% CO₂ feed without active cooling. Flow rates of 28.4 sccm, 71.1 sccm, and 144.7 sccm of the CO₂ feed were tested across a time range of between approximately 0 to 300 minutes. At a 28.4 sccm flow rate, a breakthrough concentration of approximately 1.0 was reached after approximately 400 minutes. At a 71.1 sccm flow rate, a breakthrough concentration of approximately 1.0 was reached after approximately 100 minutes. At a 144.7 sccm flow rate, a breakthrough concentration of approximately 1.0 was reached after approximately 50 minutes. Each of these tests exhibited similar pseudo-equilibrium uptake at approximately 2.1 mmol/g. At higher flow rates, the temperature increase of the composite surface was higher, reaching a temperature increase of approximately 7.7° C.

These same flow rates of 4.5% CO₂ feed were also tested to observe the overall adsorption kinetics of the structure. For flow rates of 28.4 sccm, 71.1 sccm, and 144.7 sccm of 4.5% CO₂ feed, breakthrough concentration and normalized uptake were found to each reach approximately 1.0 after approximately 5000 g*cc/mmol. It was found that normalized kinetics were slower as the flow rate was increased; however, this effect was not significant.

For the second heat-integrated structure, the effect of active cooling at a temperature of approximately 45° C. was significant, reducing the time required to reach a breakthrough concentration of 1.0. At a 4.5% CO₂ feed flow rate, without active cooling, it took approximately 42,000 g*cc/mmol to reach a breakthrough concentration of 1.0, while with active cooling, it took approximately 20,000 g*cc/mmol to reach a breakthrough concentration of 1.0.

Cooling and heating kinetics of the second heat-integrated structure were also observed while flowing 50 sccm of N₂ both with and without coolant. Without coolant, it took approximately 90 minutes to reduce the temperature from approximately 70° C. to 30° C. With coolant, it took approximately 35 minutes to reduce the temperature from approximately 70° C. to 30° C. It was also found that cooling to reach between approximately 60° C. and 50° C. was accelerated approximately 7.5 times and 3.6 times, respectively, by flowing cold water. A contactor temperature of approximately 80° C. was achieved by adjusting one or more parameters, such as water bath temperature, flow rates, and heat insulation.

The heating speed of the second heat-integrated structure was also tested. In a first heating stage, and under a slow pumping rate and low bath temperature, it took approximately 4.5 min for the composite to reach approximately 60° C. In a second heating stage, it took approximately 5 min to heat the composite from approximately 53° C. to 77° C.

The cooling speed of the second heat-integrated structure was also tested. It took approximately 6 min for the composite to reach less than approximately 50° C. using flowing cold water.

### Methods of Making Contactors

The present invention contemplates methods of making contactors, such as sorbent-based contactors.

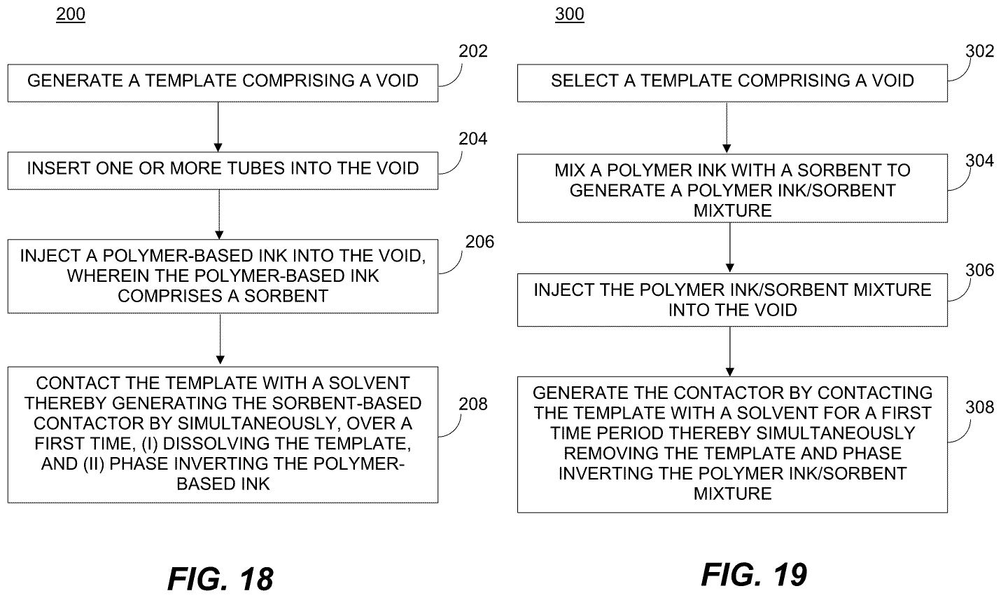

FIG. 18 is a flowchart of an exemplary method 200 of making a sorbent-based contactor.

In block 202, the method 200 may include generating a template having a void. As discussed herein, the template may be designed by a CAD program and subsequently printed using a 3D-printing technique. The template may be a reverse structure of the target geometry of the resulting sorbent-based contactor. The void may be a continuous void or may include two separate non-intersecting channels.

In block 204, the method 200 may include inserting one or more tubes into the void. As discussed herein, the tubes may be made of stainless steel, and may aid in providing thermal management of the resulting sorbent-based contactor.

In block 206, the method 200 may include injecting a polymer-based ink into the void, wherein the polymer-based ink comprises a sorbent. As discussed herein, the polymer-based ink may be injected into the void of the template.

In block 208, the method 200 may include contacting the template with a solvent thereby generating the sorbent-based contactor by simultaneously, over a first time, (i) dissolving the template, and (ii) phase inverting the polymer-based ink. As discussed herein, after injecting the polymer-based ink into the void of the template, the template may be immersed in hot water for a period of time to dissolve the template and initiate NIPS of the polymeric ink within the template simultaneously. In some embodiments, the sorbent-based contactor can include up to approximately 75 weight percent of the sorbent relative to the sorbent-based contactor.

FIG. 19 is a flowchart of an exemplary method 300 of making a contactor for use in a separation process.

In block 302, the method 300 may include selecting a template having a void. As discussed herein, a template having a specific geometry may be chosen such that the resulting contactor will have a reverse geometry from the template. The void may be a continuous void or may include two separate non-intersecting channels.

In block 304, the method 300 may include mixing a polymer ink with a sorbent to generate a polymer ink/sorbent mixture. As discussed herein, the polymer ink may include, e.g., PVP, CA, NMP, water, polyimide, and/or PES, while the sorbent may include, e.g., zeolite 13X, mesoporous silica, AC, and/or a MOF.

In block 306, the method 300 may include injecting the polymer ink/sorbent mixture into the void. This step may be the same as or similar to block 206 of method 200.

In block 308, the method 300 may include generating the contactor by contacting the template with a solvent for a first time period thereby simultaneously removing the template and phase inverting the polymer ink/sorbent mixture. This step may be the same as or similar to block 208 of method 200.

### Additional Embodiments

Embodiment 1. A contactor configured for use in a separation process, the contactor comprising: a Triply Periodic Minimal Surface (TPMS) shape; a first channel; a second channel not intersecting with the first channel; and a sorbent in an amount of up to approximately 75 weight percent of the contactor.

Embodiment 2. A method of conducting carbon capture, the method comprising: directing air, combustion gas, or refinery gas through the first channel of the contactor according to Embodiment 1; and directing a heating or cooling fluid through the second channel of the contactor.

Embodiment 3. The contactor according to Embodiment 1, wherein the TPMS shape comprises a periodic implicit surface having zero mean curvature.

Embodiment 4. The contactor according to Embodiment 3, wherein the TPMS shape comprises one or more of a gyroid, a Schwarz diamond, a Schwarz primitive, a Schoen I-WP, a Fischer Koch S, a split P, a Neovius, a lidinoid, or combinations thereof.

Embodiment 5. The contactor according to any of Embodiments 1, 3, and 4, wherein the sorbent comprises one or more of a zeolite, mesoporous silica, activated carbon (AC), a metal organic framework (MOF), a carbon nanotube, alumina, a metal oxide, a hydroxide, a covalent organic framework (COF), an ion exchange resin, an amine functionalized support material, or combinations thereof.

Embodiment 6. The contactor according to Embodiment 5, wherein the zeolite comprises zeolite 13X, and wherein the MOF comprises one or more of UiO-66(Zr), ZIF-8, HKUST-1, or combinations thereof.

Embodiment 7. A method of using the contactor according to any of Embodiments 1 and 3-6, the method comprising: flowing a gas stream comprising nitrogen (N₂) across the contactor resulting in a first pressure drop of approximately 5 to 50 times smaller than a second pressure drop associated with a pellet-based contactor.

Embodiment 8. A method of using the contactor according to any of Embodiments 1 and 3-7, the method comprising: flowing a gas stream across the contactor resulting in a first ratio of breakthrough capacity to pseudo-equilibrium capacity that is greater than a second ratio of breakthrough capacity to pseudo-equilibrium capacity associated with a fiber-shaped contactor.

Embodiment 9. A method of making a sorbent-based contactor, the method comprising: generating a template comprising a void; injecting a polymer-based ink into the void, wherein the polymer-based ink comprises a sorbent; and contacting the template with a solvent thereby generating the sorbent-based contactor by simultaneously, over a first time, (i) dissolving the template, and (ii) phase inverting the polymer-based ink, wherein the sorbent-based contactor comprises up to approximately 75 weight percent of the sorbent relative to the sorbent-based contactor.

Embodiment 10. The method according to Embodiment 9, wherein: the polymer-based ink comprises one or more of polyvinylpyrrolidone (PVP), cellulose acetate (CA), N-methyl-2-pyrrolidone (NMP), water, polyimide, polyethersulfone (PES), or combinations thereof, and wherein the solvent comprises water.

Embodiment 11. The method according to any of Embodiments 9-10, wherein the sorbent-based contactor comprises a Triply Periodic Minimal Surface (TPMS) comprising at least two non-intersecting channels, and wherein generating the template comprises: selecting a TPMS pattern; and assigning a thickness to the TPMS pattern to generate the template.

Embodiment 12. The method according to any of Embodiments 9-11, wherein generating the template is performed utilizing a three-dimensional (3D) printer, and wherein the template comprises a 3D negative of the shape of the sorbent-based contactor.

Embodiment 13. The method according to Embodiment 9, further comprising: inserting the one or more tubes into the void prior to injecting the polymer-based ink into the void, wherein the one or more tubes aid in directing a heat transfer fluid through the sorbent-based contactor to provide thermal management of the sorbent-based contactor.

Embodiment 14. The method according to Embodiment 13, wherein the one or more tubes comprise between approximately 0.6% to 0.7% of an overall volume of the sorbent-based contactor.

Embodiment 15. The method according to any of Embodiments 13-14, wherein the sorbent-based contactor provides a CO₂ uptake of between approximately 1.2 to 1.9 mmol/gram after approximately 5 hours of flowing a dry approximately 4.5% CO₂ feed.

Embodiment 16. The method according to any of Embodiments 13-15, wherein the sorbent-based contactor provides a CO₂ uptake of between approximately 2.5 to 4.0 mmol/gram after approximately 45 minutes of flowing an approximately 4.5% CO₂ feed of approximately 50% relative humidity.

Embodiment 17. The method according to Embodiment 9, wherein the template comprises poly(vinyl alcohol) (PVA), butenediol vinyl alcohol (BVOH), a High Impact Polystyrene (HIPS), or combinations thereof.

Embodiment 18. A method of making a contactor for use in a separation process, the method comprising: selecting a template comprising a void; mixing a polymer ink with a sorbent to generate a polymer ink/sorbent mixture; injecting the polymer ink/sorbent mixture into the void; and generating the contactor by contacting the template with a solvent for a first time period thereby simultaneously removing the template and phase inverting the polymer ink/sorbent mixture, wherein the contactor comprises up to approximately 75 weight percent of the sorbent relative to the contactor.

Embodiment 19. The method according to Embodiment 18, wherein the polymer ink comprises one or more of cellulose acetate (CA), N-methyl-2-pyrrolidone (NMP), water, polyimide, polyethersulfone (PES), or combinations thereof.

Embodiment 20. The method according to any of Embodiments 18-19, wherein the solvent comprises water, wherein the first time period comprises at least one hour, and wherein contacting the template with water comprises submerging the template in hot water and replacing the hot water at least once.

Certain features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

The foregoing description of the disclosure illustrates and describes the present methodologies. Additionally, the disclosure shows and describes exemplary methods, but it is to be understood that various other combinations, modifications, and environments may be employed, and the present methods are capable of changes or modifications within the scope of the concept as expressed herein, commensurate with the above teachings and/or the skill or knowledge of the relevant art.

What is claimed is:

1. A contactor configured for use in a separation process, the contactor comprising:
a Triply Periodic Minimal Surface (TPMS) shape;
a first channel;
a second channel not intersecting with the first channel; and
a sorbent in an amount of up to approximately 75 weight percent of the contactor.

2. A method of conducting carbon capture, the method comprising:
directing air, combustion gas, or refinery gas through the first channel of the contactor of claim 1; and
directing a heating or cooling fluid through the second channel of the contactor.

3. The contactor of claim 1, wherein the TPMS shape comprises a periodic implicit surface having zero mean curvature.

4. The contactor of claim 3, wherein the TPMS shape comprises one or more of a gyroid, a Schwarz diamond, a Schwarz primitive, a Schoen I-WP, a Fischer Koch S, a split P, a Neovius, a lidinoid, or combinations thereof.

5. The contactor of claim 1, wherein the sorbent comprises one or more of a zeolite, mesoporous silica, activated carbon (AC), a metal organic framework (MOF), a carbon nanotube, alumina, a metal oxide, a hydroxide, a covalent organic framework (COF), an ion exchange resin, an amine functionalized support material, or combinations thereof.

6. The contactor of claim 5, wherein the zeolite comprises zeolite 13X, and wherein the MOF comprises one or more of UiO-66(Zr), ZIF-8, HKUST-1, or combinations thereof.

7. A method of using the contactor of claim 1, the method comprising:
flowing a gas stream comprising nitrogen (N₂) across the contactor resulting in a first pressure drop of approximately 5 to 50 times smaller than a second pressure drop associated with a pellet-based contactor.

8. A method of using the contactor of claim 1, the method comprising:
flowing a gas stream across the contactor resulting in a first ratio of breakthrough capacity to pseudo-equilibrium capacity that is greater than a second ratio of breakthrough capacity to pseudo-equilibrium capacity associated with a fiber-shaped contactor.

9. A method of making a sorbent-based contactor, the method comprising:
generating a template comprising a void;
injecting a polymer-based ink into the void, wherein the polymer-based ink comprises a sorbent; and
contacting the template with a solvent thereby generating the sorbent-based contactor by simultaneously, over a first time, (i) dissolving the template, and (ii) phase inverting the polymer-based ink,
wherein the sorbent-based contactor comprises up to approximately 75 weight percent of the sorbent relative to the sorbent-based contactor.

10. The method of claim 9, wherein:
the polymer-based ink comprises one or more of polyvinylpyrrolidone (PVP), cellulose acetate (CA), N-methyl-2-pyrrolidone (NMP), water, polyimide, polyethersulfone (PES), or combinations thereof; and
wherein the solvent comprises water.

11. The method of claim 9, wherein the sorbent-based contactor comprises a Triply Periodic Minimal Surface (TPMS) comprising at least two non-intersecting channels, and wherein generating the template comprises:
selecting a TPMS pattern; and
assigning a thickness to the TPMS pattern to generate the template.

12. The method of claim 9, wherein generating the template is performed utilizing a three-dimensional (3D) printer, and wherein the template comprises a 3D negative of the shape of the sorbent-based contactor.

13. The method of claim 9, further comprising:
inserting one or more tubes into the void prior to injecting the polymer-based ink into the void,
wherein the one or more tubes aid in directing a heat transfer fluid through the sorbent-based contactor to provide thermal management of the sorbent-based contactor.

14. The method of claim 13, wherein the one or more tubes comprise between approximately 0.6% to 0.7% of an overall volume of the sorbent-based contactor.

15. The method of claim 14, wherein the sorbent-based contactor provides a CO₂ uptake of between approximately 1.2 to 1.9 mmol/gram after approximately 5 hours of flowing a dry approximately 4.5% CO₂ feed.

16. The method of claim 14, wherein the sorbent-based contactor provides a CO₂ uptake of between approximately 2.5 to 4.0 mmol/gram after approximately 45 minutes of flowing an approximately 4.5% CO₂ feed of approximately 50% relative humidity.

17. The method of claim 9, wherein the template comprises poly(vinyl alcohol) (PVA), butenediol vinyl alcohol (BVOH), a High Impact Polystyrene (HIPS), or combinations thereof.

18. A method of making a contactor for use in a separation process, the method comprising:
selecting a template comprising a void;
mixing a polymer ink with a sorbent to generate a polymer ink/sorbent mixture;
injecting the polymer ink/sorbent mixture into the void; and
generating the contactor by contacting the template with a solvent for a first time period thereby simultaneously removing the template and phase inverting the polymer ink/sorbent mixture,
wherein the contactor comprises up to approximately 75 weight percent of the sorbent relative to the contactor.

19. The method of claim 18, wherein the polymer ink comprises one or more of cellulose acetate (CA), N-methyl-2-pyrrolidone (NMP), water, polyimide, polyethersulfone (PES), or combinations thereof.

20. The method of claim 18, wherein the solvent comprises water, wherein the first time period comprises at least one hour, and wherein contacting the template with water comprises submerging the template in hot water and replacing the hot water at least once.
